(19) United States
(12) Patent Application Publication
(10) Pub. No.: US 2003/0074236 A1
(43) Pub. Date: Apr. 17, 2003

(54) Ship-charter contracting system, server and database for the system, and ship-charter contract aiding method

(76) Inventors: Masao Watanabe, Tokyo (JP); Kouhei Tsutsumi, Tokyo (JP); Masako Mori, Tokyo (JP)

Correspondence Address: GREENBLUM & BERNSTEIN, P.L.C., 1941 ROLAND CLARKE PLACE, RESTON, VA, 20191, US

(21) Appl. No.: 09/926,797

(22) PCT Filed: Apr. 25, 2001
(86) PCT No.: PCT/JP01/03567

(30) Foreign Application Priority Data
Apr. 27, 2000 (JP) 2000-127934

(51) Int. Cl. G06F 17/60

(52) U.S. Cl. 705/5

(57) ABSTRACT

To provide a vessel charter supporting system which is characterized by including: a network terminal for a charterer 27 owned by a charterer; a network terminal for an owner 28 owned by an owner; a database 25 for storing predetermined information required for a vessel charter; information entered by the above-described charterer and information entered by the above-described owner: and a server 24 for forming a screen for entering predetermined information or a screen for displaying information based on information entered from the network terminal for a charterer 27, information entered from the network terminal for an owner 28 and information stored in the database 25 and supporting conclusion of a vessel charter while causing the network terminal for a charterer 27 and the network terminal for an owner 28 to appropriately display the screen, respectively.

### TECHNICAL FIELD

The present invention relates to a vessel charter supporting system for supporting a vessel charter to be entered into between a vessel owner who owns vessels or operates vessels (hereinafter referred to as owner) and a vessel charterer (hereinafter referred to as charterer), a server and a database therefor, and a method of supporting a vessel charter.

### BACKGROUND ART

Conventionally, an enquiry for a vessel charter for a vessel such as a tanker is generally performed by a broker intervening between a charterer and an owner.

FIGS. 49 and 50 are a flow chart showing a flow of procedures for an enquiry of a vessel charter to be entered into with intervention of a broker. The flow of the conventional procedures for a vessel charter will be hereinafter described with reference to FIGS. 49 and 50.

First, a charterer requiring transportation of cargoes (oil) requests a broker to send an enquiry for a vessel charter by telephone (S1). The broker having received the request contacts an owner concerning a content of the request (S2) and causes the owner to select a vessel that meets the needs of the charterer and determine a vessel to be rented out (S4). The owner having determined subjects for renting out the vessel contacts the broker concerning the subjects (S5), and the broker confirms the subjects and informs the charterer of them (S6).

The charterer having been contacted by the broker confirms the subjects and then determines whether the charterer continues the procedures (S9) or not (S8). In case of continuing the procedures, the charterer informs the broker to the effect that the charterer have determined a vessel to be chartered and of items of negotiation and contents of them for chartering the vessel (S9), and the broker confirms the items of negotiation or the like to inform the owner of them (S10). The owner confirms the items of negotiation and the contents of them (S11) and then determines a policy of negotiation to inform the broker of it (S12), and the broker confirms items of negotiation on the owner side to inform the charterer of them (S13).

The charterer confirms the items of negotiation presented by the owner side (S14) and, when the items determined, informs the broker to that effect (S15), the broker makes a final confirmation of the subjects for chartering presented by the charterer side (S16), and the owner makes a final confirmation about the subjects for chartering presented by the charterer side (S17). When the broker is informed of a final decision of renting out the vessel by the owner who made the final decision (S18), the broker makes a final confirmation of the subjects for chartering to inform the charterer of them and, at the same time, prepares a fixture recap being a charter (S19) and send it to the charterer and the owner by an e-mail or facsimile (S21).

The charterer having been contacted by telephone from the broker confirms understanding of the owner side (S20) by receiving the fixture recap sent from the broker (S23), and the owner also can confirm items of the final decision of the subjects for renting out the vessel (S18) by receiving the fixture recap sent from the broker (S22).

Further, in the above-mentioned procedures, the negotiation procedures shown in steps S9 to S14 may be repeated for a plurality of times (e.g., four or five times) until the negotiation is completed.

As described above, the negotiation is performed by mainly using telephones with the intervention of the broker between a charterer and the owner in the conventional procedures of enquiry for the vessel charter.

However, subjects have to be defined for extremely many items in an enquiry for a vessel charter, and it is hard to aurally comprehend a negotiation in some cases even if it is performed using a unified language (English), which makes it extremely difficult to grasp contents of the negotiation compared with information transaction to be performed using sight. On the other hand, if a negotiation is performed using facsimiles, a large amount of time and labor are consumed in exchanges of information for a multiplicity of times such as setting subjects.

In addition, since a charterer and an owner do not negotiate directly due to the intervention of a broker in the conventional procedures for an enquiry, loss in time for communicating information is caused and, for the owner side, a brokerage fee to be paid to the broker is required and expenses for chartering a vessel increases. Further, if at least one of the charterer, the broker and the owner stays in a foreign country, a problem of a time difference is also caused.

Moreover, since the conventional procedures for an enquiry is performed mainly by telephones, contents of items of a negotiation mutually agreed upon between a charterer and an owner have to be described one by one in preparing a fixture recap or a charter, which therefore requires a large amount of labor for preparing these documents.

The present invention has been achieved in view of the above-mentioned circumstances, and it is an object of the present invention to provide a vessel charter supporting system with which a charterer and an owner can conclude a vessel charter easily, quickly and accurately without the intervention of a broker, a server and a database therefor, and a method of supporting a vessel charter.

### DISCLOSURE OF THE INVENTION

A vessel charter supporting system in accordance with the present invention is a vessel charter supporting system for supporting a vessel charter to be entered into between an owner and a charterer, characterized by comprising: an information terminal for a charterer owned by the above-described charterer; an information terminal for an owner owned by the above-described owner; a storage unit for storing predetermined information required for the above-described vessel charter, information entered by the above-described charterer and information entered by the above-described owner; and a control unit for forming a screen for entering predetermined information or a screen for displaying information based on information entered from the above-described information terminal for a charterer, information entered from the above-described information terminal for an owner and information stored in the above-described storage unit to support conclusion of the vessel charter while causing the above-described information terminal for a charterer and the above-described information terminal for an owner to appropriately display the screens, respectively.

According to such a configuration, the charterer and the owner can proceed with procedures for a vessel charter using the respective information terminals and visually confirming the screens displayed on the respective information terminals without the intervention of the broker and can conclude the vessel charter easily, quickly and accurately.

In addition, the vessel charter supporting system in accordance with the present invention is characterized in that the above-described screen for entering predetermined information includes an enquiry information entry screen displayed on the above-described information terminal for a charterer for entering enquiry information concerning a vessel that meets conditions with which the above-described charterer intends to charter the vessel or a predetermined vessel that the above-described charterer intends to charter and causing the owner to present an indication for the enquiry.

Since such an enquiry information entry screen is provided, the charterer can easily make an enquiry about a vessel which is required for a vessel charter.

In addition, the vessel charter supporting system in accordance with the present invention is characterized in that the above-described enquiry information entry screen includes at least one of a screen for making an enquiry not specifying an owner or a screen for making an enquiry specifying at least one owner.

According to such a configuration, the charterer can easily make an enquiry to an unspecified number of owners or an enquiry to a specified owner.

Moreover, the vessel charter supporting system in accordance with the present invention is characterized in that the above-described screen for entering predetermined information includes a screen for entering indication information for the above-described owner to enter an indication to the above-described enquiry information from the above-described information terminal for an owner and presenting the indication information to the above-described charterer.

Since such a screen for entering indication information is provided, the owner can easily present an indication to an enquiry from the charterer.

In addition, the vessel charter supporting system in accordance with the present invention is characterized in that the above-described screen for displaying information includes a screen for displaying indication information for causing the above-described information terminal for a charterer to display an indication from the above-described owner to enquiry information from the above-described charterer.

Since such a screen for entering indication information is provided, the charterer can easily learn an indication from the owner.

Moreover, the vessel charter supporting system in accordance with the present invention is characterized in that, if indications are received from a plurality of owners, the indications are also shown on the above-described screen for displaying indication information.

As described above, since indications from a plurality of owners are also shown, it becomes easy for the charterer to compare an indication presented by each owner and select an owner with whom the charterer can enter into a preferable vessel charter.

In addition, the vessel charter supporting system in accordance with the present invention is characterized in that the above-described screen for displaying indication information is provided with an expression of intention information entering section for designating an owner with whom the charterer negotiates and expressing an intention for shifting to a negotiation.

Since such an expression of intention information entering section is provided, the charterer can easily shift to a negotiation with a designated owner.

Moreover, the vessel charter supporting system in accordance with the present invention is characterized in that, if expression of intention information for shifting to a negotiation is entered by the above-described expression of intention information entering section, the above-described control unit sends the expression of intention information to the above-described information terminal for an owner in order to cause it to display the information in a predetermined form and, at the same time, sends the above-described expression of intention information to the above-described owner in order to inform it of the information using another information communication form.

According to such a configuration, the owner can learn a request for a negotiation from the charterer easily and quickly and procedures up to conclusion of a vessel charter becomes quick.

In addition, the vessel charter supporting system in accordance with the present invention is characterized in that the above-described control unit causes each of the above-described information terminal for a charterer and the above-described information terminal for an owner to display a screen for entering information for each item of a negotiation in negotiating a vessel charter.

According to such a configuration, it becomes easy for the charterer and the owner to grasp items of a negotiation, which leads to easy and quick procedures for a negotiation.

Moreover, the vessel charter supporting system in accordance with the present invention is characterized in that the above-described screen for entering information for each item of a negotiation is provided with communicating means for displaying contents of the same item of a negotiation entered by the other party of the negotiation and informing to the effect that displayed contents is agreed upon with the other party of a negotiation.

According to such a configuration, conditions of the other party of a negotiation, whether or not the other party has an intention to agree, and the like can be grasped easily, quickly and accurately, which leads to easy and quick procedures of a negotiation and can increase its accuracy significantly.

In addition, the vessel charter supporting system in accordance with the present invention is characterized in that a list of a plurality of items of a negotiation is also displayed on the above-described screen for entering information for each item of a negotiation and contents of the items of a negotiation agreed upon are displayed in association with each item of a negotiation in the list of the items of a negotiation.

According to such a configuration, since the owner and the charterer can develop a negotiation to the next step while confirming the contents of a negotiation agreed upon, confirmation about the contents of the agreement becomes easy and the procedures becomes efficient.

Moreover, the vessel charter supporting system in accordance with the present invention is characterized in that, if contents of items of a charter agreed upon is displayed in association with all necessary predetermined items of a negotiation in the above-mentioned items of a negotiation, the displayed contents in the list of the items of a negotiation is regarded as contents of a vessel charter.

According to such a configuration, since the displayed contents of a screen for confirming agreed contents automatically becomes contents of a charter, separate procedures for preparing a charter or the like becomes unnecessary and procedures for a vessel charter becomes quick.

In addition, the vessel charter supporting system in accordance with the present invention is characterized in that the above-described screen for entering information for each item of a negotiation has a first message entering section for entering a message to be shown to the other party of a negotiation which is not reflected on the above-described contents of a vessel charter and a first message displaying section in which the message entered in the above-described first message entering section is shown to the other party of a negotiation.

According to such a configuration, since a message that is not reflected on contents of a vessel charter can be freely exchanged with the other party during a negotiation, mutual communication better than that in a negotiation of a charter can be realized and, as a result, a vessel charter can be concluded smoothly.

Moreover, the vessel charter supporting system in accordance with the present invention is characterized in that the above-described contents of a vessel charter is contents of a vessel charter with conditions, and the above-described screen for entering predetermined information in the above-described information terminal for a charterer is provided with a conditions lifting entering section for entering to the effect that conditions are lifted with respect to the above-mentioned contents of a vessel charter with conditions, a charter failure entering section for entering to the effect that a charter is failed to be concluded and change entering section for entering to the effect that the above-described contents of a vessel charter with conditions are changed.

In this way, since contents of a concluded vessel charter are with conditions, a chance for further amending the contents of the charter is created, whereby the contents of the vessel charter can be made more desirable for the charterer. In addition, since the charterer can regard a charter as failure unless conditions are lifted, there will be no unexecutable charter and a vessel charter conforming to reality can be concluded.

Further, the above-mentioned conditions are conditions in terms of whether situations for actually executing a charter are complete and are equivalent to four subjects, STEM/SUPPLIERS/RECEIVERS/CHARTERER'S MANAGEMENT'S APPROVAL (a problem of a cargo, an approval of suppliers, an approval of receivers and a management's approval) in a third embodiment of the present invention. These subjects are not lifted at the point when a vessel charter is concluded. The charterer itself confirms these subjects and, if the subjects are cleared, lifts the subjects of the vessel charter and, if the subjects are not cleared, regards the vessel charter as failed (Sub Failed).

In addition, the vessel charter supporting system in accordance with the present invention is characterized in that, if change is entered by the above-described change entering section, the above-described control unit causes each of the above-described information terminal for a charterer and the above-described information terminal for an owner to display a change entering screen for entering information for change including at least one of amendment, addition and deletion with respect to the above-described contents of the vessel charter with conditions.

According to such a configuration, contents of the change can be easily entered with respect to the contents of the vessel charter with conditions. Further, the screen for entering change is equivalent to each screen for a negotiation of a Clean Recap Negotiation Room in the third embodiment of the present invention, with which the charterer and the owner can proceed with a negotiation while mutually entering contents of change.

In addition, the vessel charter supporting system in accordance with the present invention is characterized in that change information to be entered on the above-described screen for entering change includes addition of a charter clause.

According to such a configuration, since the charterer can easily add a charter clause, contents of the charter can be made desirable for the charterer.

Moreover, the vessel charter supporting system in accordance with the present invention is characterized in that the above-described screen for entering predetermined information includes a charter clause preparing screen that is displayed on the above-described terminal for a charterer and prepares the above-described charter clause, the above-described storage unit is provided with a first database for storing the above-described prepared charter clause, and an entering of an additional charter clause to be performed on the above-described change entering screen includes a quotation of the charter clause stored in the above-described first database.

According to such a configuration, since the charterer can register a charter clause, which is likely to be added, in a system in advance, if registered contents are used at the time of entering an additional clause, trouble of entering can be reduced and processing of a negotiation becomes quick. Further, in the third embodiment of the present invention, a charter clause that the charterer desires to add in the Clean Recap Negotiation Room can be easily selected out of charter clauses, which are registered in the system in advance, by a pull-down menu, and contents of the selected charter clauses are directly pasted to an entering area for adding a charter clause.

In addition, the vessel charter supporting system in accordance with the present invention is characterized in that the above-described change entering screen is provided with a change contents displaying section for displaying the above-described contents of change entered by the above-described other party of a negotiation.

According to such a configuration, since the contents of change entered by the other party of a negotiation can be easily grasped and further change can be easily made with respect to the displayed contents of change, it becomes possible to smoothly develop a negotiation.

Moreover, the vessel charter supporting system in accordance with the present invention is characterized in that, among the contents of change to be displayed on the above-described change contents displaying section, a displaying form of at least one of an amended part, an added part and a deleted part is different from a displaying form of parts other than a changed part.

According to such a configuration, since a changed part and an unchanged part can be easily distinguished, a negotiation can be developed smoothly.

In addition, the vessel charter supporting system in accordance with the present invention is characterized in that the above-described change entering screen is provided with an agreement on change of conditions communicating section for informing the above-described party of a negotiation to the effect that the contents displayed on the above-described contents of change displaying section is agreed upon, and, if the parties of a negotiation mutually agreed, agreed contents of change are reflected on the above-described contents of the vessel charter with conditions.

According to such a configuration, the owner and the charterer can grasp that the contents of change are agreed upon easily, quickly and accurately, which leads to easy and quick procedures of a negotiation and can increase its accuracy significantly. Moreover, if the agreed contents are reflected on the contents of the vessel charter, trouble of preparing a vessel charter can be reduced and procedures for a vessel charter becomes quick.

In addition, the vessel charter supporting system in accordance with the present invention is characterized in that the above-described change entering screen has a second message entering section for entering a message to be shown to the other party of a negotiation which is not reflected on the above-described contents of change and a second message displaying section in which a message entered in the above-described second message entering section is shown to the other party of a negotiation.

With such a configuration, since a message that is not reflected on contents of a vessel charter can be freely exchanged with the other party during a negotiation, mutual communication better than that in a negotiation of a charter can be realized and, as a result, a negotiation for change of a vessel charter can be furthered smoothly.

Moreover, the vessel charter supporting system in accordance with the present invention is characterized in that, if an entering is made by the above-described conditions lifting entering section from the above-described terminal for a charterer, the above-described control unit regards the above-described contents of the vessel charter with conditions as contents of a vessel charter from which conditions are lifted.

According to such a configuration, since the vessel charter with conditions can be regarded as a vessel charter from which conditions are lifted only when an entering to the effect that the charterer lifted the conditions is made and it is sufficient for a charterer to lift conditions only when conditions required for chartering a vessel such as a problem of a cargo, an approval of suppliers, an approval of receivers and a management's approval were successfully cleared.

In addition, the vessel charter supporting system in accordance with the present invention is characterized in that the above-described screen for entering predetermined information in the above-described information terminal for an owner includes a confirmation screen for confirming the above-described contents of a vessel charter from which conditions are lifted if an entering is made by the above-described conditions lifting entering section, and the above-described confirmation screen is provided with a confirmation entering section for entering to the effect that the owner confirmed the above-described contents of a vessel charter from which conditions are lifted and transmits the above-described contents of a vessel charter from which conditions are lifted to the above-described information terminal for a charterer and the above-described information terminal for an owner if an entering of confirmation is made by the above-described confirmation entering section.

According to such a configuration, since the owner can easily confirm that the conditions have been lifted and the contents of a vessel charter from which conditions are lifted are transmitted to the charterer and the owner after the confirmation, the charterer and the owner can easily grasp the final contents of a vessel charter.

Moreover, the vessel charter supporting system in accordance with the present invention is characterized in that the above-described storage unit includes a second database in which position information of a plurality of vessels, and the above-described control unit displays the position information of vessels registered in the above-described second database as a position list based on predetermined information entered from the above-described information terminal for a charterer.

According to such a configuration, since the charterer can easily learn the position information of a plurality of vessels, it becomes possible for the charterer to easily and quickly perform selection of a vessel that the charterer intends to charter or the like.

In addition, the vessel charter supporting system in accordance with the present invention is characterized in that the above-described position list includes schematic information of each vessel in addition to position information of each of the above-described plurality of vessels and predetermined conditions concerning the contents of the above-described schematic information is set and entered from the above-described information terminal for a charterer, whereby the above-described control unit selectively displays only a vessel that meets the above-described set and entered predetermined conditions from the above-described position list.

According to such a configuration, it becomes possible for the charterer to easily find a vessel meeting desired conditions or the like from the position list.

Moreover, the vessel charter supporting system in accordance with the present invention is further provided with a position information update entering section for updating position information of a vessel to be displayed as the above-described position list and is characterized in that the above-described control unit updates the above-described second database based on update information entered by the above-described position information update entering section.

According to such a configuration, since the position list can be updated according to change of position information of a vessel, it becomes possible for the charterer to refer to data conforming to a real situation and the charterer can make an enquiry of a vessel accurately.

In addition, the vessel charter supporting system in accordance with the present invention is characterized in that the above-described storage unit includes a third database in which detailed information about each vessel that is displayed in the above-described position list is registered, and the above-described position list is provided with a detailed information request instructing section for causing the above-described information terminal for a charterer to display the above-described detailed information about each vessel based on the above-described third database.

According to such a configuration, the charterer can easily and quickly obtain more detailed information about a vessel in which the charterer is interested in the position list.

Moreover, the vessel charter supporting system in accordance with the present invention is further provided with a detailed information update entering section for updating detailed information about the above-described each vessel and is characterized in that the above-described control unit updates the above-described third database based on update information entered by the above-described detailed information update entering section.

According to such a configuration, since detailed information registered in the database can be updated according to change of detailed information of a vessel, it becomes possible for the charterer to refer to data conforming to a real situation and the charterer can make an enquiry of a vessel accurately.

In addition, the vessel charter supporting system in accordance with the present invention is characterized in that at least one of the above-described position list and a display screen on which detailed information about each vessel that was displayed in the above-described position list is displayed is provided with an enquiry information entering section for making an enquiry concerning the displayed vessel.

According to such a configuration, the charterer can make an enquiry with respect to a predetermined vessel easily.

Moreover, the vessel charter supporting system in accordance with the present invention is characterized in that a history concerning a vessel charter entered into between the above-described charterer and the above-described owner is stored in the above-described storage unit.

According to such a configuration, it becomes easy for the charterer and the owner to resume a vessel charter that has been pending or to use contents of a charter entered into in the past again and a vessel charter is concluded quickly.

In addition, the vessel charter supporting system in accordance with the present invention is characterized in that the above-described history includes contents of a charter entered into in the past and the history is made displayable appropriately on a screen of each information terminal such that the charterer or the owner can perform a negotiation smoothly.

According to such a configuration, since the charterer or the owner can perform a negotiation while visually recognizing the contents of the charter in the past, it become possible to perform a negotiation smoothly.

In addition, a method of supporting a vessel charter in accordance with the present invention is a method of supporting a vessel charter for supporting a vessel charter to be entered into between an owner and a charterer using computers and communication lines which comprises the steps of: an enquiring step of entering an enquiry concerning a vessel that meets conditions with which the above-described charterer intends to charter a vessel or a predetermined vessel that the above-described charterer intends to charter from an information terminal for a charterer and causing the owner to present an indication for the enquiry; a replying step in which the owner enters an indication to enquiry information from the above-described charterer from an information terminal for an owner and presents it to the charterer; a shifting to negotiation step of shifting to a negotiation with a predetermined owner based on said indication information presented by the above-described owner; and a step in which the charterer and the owner perform a negotiation using an information terminal for a charterer and an information terminal for an owner.

According to such a configuration, the charterer and the owner can proceed with procedures for a vessel charter using the respective information terminals and visually confirming the screens displayed on the respective information terminals without the intervention of the broker and can conclude the vessel charter easily, quickly and accurately.

Moreover, the method of supporting a vessel charter in accordance with the present invention is characterized in that the above-described step of performing a negotiation is provided with a first step of displaying a list of a plurality of negotiation items on each of the display screen of the above-described information terminal for a charterer and the above-described information terminal for an owner and at the same time displaying a predetermined screen for entering information for one of items that are not negotiated among the above-described plurality of negotiation items to cause the above-described charterer and the above-described owner to enter contents of the negotiation; a second step of asking whether or not the above-described charterer and the above-described owner agree on the contents of the negotiation entered by them and causing them to indicate determination of intentions; and a third step of setting to display the agreed contents of the negotiation with respect to the above-described one negotiation item in the above-described list of the negotiation items in association with the above-described agreed negotiation items and returning to the above-described first step, and that the above-described step of performing a negotiation repeats the above-described first to the third step to conclude a vessel charter by filling necessary negotiation items in the above-described negotiation items with the contents of the negotiation.

According to such a configuration, procedures for a vessel charter can be performed easily, quickly and accurately and, at the same time, for example, if the agreed negotiation items are reflected on a vessel charter as they are, the vessel charter can be automatically prepared.

In addition, the method of supporting a vessel charter in accordance with the present invention is characterized in that the above-described concluded vessel charter is a vessel charter with conditions and the method is further provided with a situation entering step in which the above-described charterer enters any one of situations in that conditions are lifted, a charter is failed or conditions are to be amended using the above-described information terminal for a charterer to communicate the situation to the above-described owner; an amendment entering step of displaying a screen for entering predetermined condition information on the above-described information terminal for a charterer and the above-described information terminal for an owner with respect to conditions that the above-described charterer desires to amend to cause the above-described charterer to enter contents of amendment for the conditions if the situation entered above-described entering step is amendment of conditions; and an intention determining step of entering determination of an intention on whether or not the above-described charterer and the above-described owner agree with each other about the contents of amendment entered by them, and the above-described situation entering step, the above-described amendment entering step and the above-described intention determining step are repeated until lifting of conditions or failure of a charter is entered in the above-described situation entering step.

In this way, since contents of a concluded vessel charter is with conditions, a chance for further amending the contents of the charter is created, whereby the contents of the vessel charter can be made more desirable for the charterer. Moreover, since a negotiation for amending contents of a vessel charter with conditions can be performed until conditions are lifted or a charter is regarded as failed, contents of a charter desirable for the charterer can be formed. In addition, since the charterer can regard a charter as failure unless conditions are lifted, there will be no unexecutable charter and a vessel charter conforming to reality can be concluded.

Moreover, the method of supporting a vessel charter in accordance with the present invention is characterized in that, if the situation entered in the above-described situation entering step is lifting of conditions, the above-described contents of a vessel charter with conditions becomes contents of a vessel charter from which conditions are lifted and the method is further provided with a confirmation entering step in which the above-described owner confirms entering to the effect that the above-described lifting of conditions using the above-described information terminal for an owner with respect to the above-described contents of a vessel charter from which the conditions are lifted; and a conditions lifted vessel charter contents transmitting step of transmitting the above-described contents of a vessel charter from which the conditions are lifted to the above-described information terminal for a charterer and the above-described information terminal for an owner if an entering of confirmation is made in the above-described confirmation entering step.

According to such a method, since the owner can easily confirm that conditions are lifted and the contents of a vessel charter from which conditions are lifted are sent to the charterer and the owner after the confirmation, final contents of a vessel agreement can be grasped easily.

In addition, the present invention is a server that is used in a vessel charter supporting system for supporting a vessel charter to be entered into between an owner and a charterer using computers and communication lines which is characterized in that it is used for controlling information communication between an information terminal for a charterer and an information terminal for an owner in procedures for a vessel charter in which the above-described charterer uses the above-described information terminal to make an enquiry concerning a vessel meeting conditions for chartering a vessel or a predetermined vessel that the above-described charterer intends to charter and the above-described owner uses the above-described information terminal for an owner to make an indication to the enquiry from the above-described charterer, and the charterer shifts to a negotiation step based on indication information from the above-described owner, where the above-described charterer and the above-described owner performs a negotiation.

According to such a server, the charterer and the owner can conclude a vessel charter while exchanging information using the information terminals.

In addition, the present invention is a database that is used in a vessel charter supporting system for supporting a vessel charter to be entered into between an owner and a charterer using computers and communication lines which is characterized in that it is used for storing predetermined information required for a vessel charter, information entered by the above-described charterer and information entered by the above-described owner in procedures for a vessel charter in which the above-described charterer uses the above-described information terminal to make an enquiry concerning a vessel meeting conditions for chartering a vessel or a predetermined vessel that the above-described charterer intends to charter and the above-described owner uses the above-described information terminal for an owner to make an indication to the enquiry from the above-described charterer, and the charterer shifts to a negotiation step based on indication information from the above-described owner, where the above-described charterer and the above-described owner performs a negotiation.

According to such a database, since predetermined information required for a vessel charter can be stored, the charterer and the owner can conclude a vessel charter easily, quickly and accurately while exchanging information using the information terminals.

In addition, the present invention is a program for supporting a vessel charter to be entered into between an owner and a charterer using computers and communication lines which is characterized by causing the computers to execute an enquiring step of entering an enquiry concerning a vessel that meets conditions with which the above-described charterer intends to charter a vessel or a predetermined vessel that the above-described charterer intends to charter from an information terminal for a charterer and causing the owner to present an indication for the enquiry; a replying step in which the owner enters an indication to enquiry information from the above-described charterer and presents it to the charterer; a shifting to negotiation step of shifting to a negotiation with a predetermined owner based on the indication information presented by the above-described owner; and a step in which the charterer and the owner perform a negotiation using an information terminal for a charterer and an information terminal for an owner.

If the computer is caused to execute such a program, the charterer and the owner can proceed with procedures for a vessel charter while using the respective information terminals and visually confirming a screen displayed on the respective information terminals without the intervention of a broker and can conclude a vessel charter simply, accurately and quickly.

Moreover, the program for supporting a vessel charter in accordance with the present invention is characterized in that the above-described negotiation step is provided with a first step of displaying a list of a plurality of negotiation items on each of the display screen of the above-described information terminal for a charterer and the above-described information terminal for an owner and at the same time displaying a predetermined screen for entering information for one of items that are not negotiated among the above-described plurality of negotiation items to cause the above-described charterer and the above-described owner to enter contents of the negotiation; a second step of asking whether or not the above-described charterer and the above-described owner agree on the contents of the negotiation entered by them and causing them to indicate determination of intentions; and a third step of setting to display the agreed contents of the negotiation with respect to the above-described one negotiation item in the above-described list of the negotiation items in association with the above-described agreed negotiation items and returning to the above-described first step, and that the above-described negotiation step repeats the above-described first to the third step to conclude a vessel charter by filling necessary negotiation items in the above-described negotiation items with the contents of the negotiation.

If the computers are caused to execute such a program, it becomes possible to perform procedures for a vessel charter easily, quickly and accurately.

In addition, the program for supporting a vessel charter in accordance with the present invention is characterized in that the above-described concluded vessel charter is a vessel charter with conditions and the program is further provided with a situation entering step in which the above-described charterer enters any one of situations in that conditions are lifted, a charter is failed or conditions are to be amended using the above-described information terminal for a charterer to communicate the situation to the above-described owner; an amendment entering step of displaying a screen for entering predetermined condition information on the above-described information terminal for a charterer and the above-described information terminal for an owner with respect to conditions that the above-described charterer desires to amend to cause the above-described charterer to enter contents of amendment for the conditions if the situation entered in the above-described situation entering step is amendment of conditions; and an intention determining step of entering determination of an intention on whether or not the above-described charterer and the above-described owner agree with each other about the contents of amendment entered by them, and the above-described situation entering step, the above-described amendment entering step and the above-described intention determining step are repeated until lifting of conditions or failure of a charter is entered in the above-described situation entering step.

If such the computers are caused to execute such a program, a chance for further amending the contents of the charter is created, whereby the contents of the vessel charter can be made more desirable for the charterer. Moreover, since a negotiation for amending contents of a vessel charter with conditions can be performed until conditions are lifted or a charter is regarded as failed, contents of a charter desirable for the charterer can be formed. In addition, since the charterer can regard a charter as failure unless conditions are lifted, there will be no unexecutable charter and a vessel charter conforming to reality can be concluded.

Moreover, the program for supporting a vessel charter in accordance with the present invention is characterized in that, if the situation entered in the above-described situation entering step is lifting of conditions, the above-described contents of a vessel charter with conditions becomes contents of a vessel charter from which conditions are lifted and the method is further provided with a confirmation entering step in which the above-described owner confirms entering to the effect that the above-described lifting of conditions using the above-described information terminal for an owner with respect to the above-described contents of a vessel charter from which the conditions are lifted; and a conditions lifted vessel charter contents transmitting step of transmitting the above-described contents of a vessel charter from which the conditions are lifted to the above-described information terminal for a charterer and the above-described information terminal for an owner if an entering of confirmation is made in the above-described confirmation entering step.

If such the computers are caused to execute such a program, since the owner can easily confirm that conditions are lifted and the contents of a vessel charter from which conditions are lifted are sent to the charterer and the owner after the confirmation, final contents of a vessel agreement can be grasped easily.

### BRIEF DESCRIPTION OF THE DRAWINGS

FIG. 1 is a view showing a schematic hardware configuration of a vessel charter supporting system in accordance with a first embodiment of the present invention;

FIG. 2 is a flow chart showing a flow of procedures of a vessel charter utilizing the system;

FIG. 3 is a flow chart showing a flow of procedures of the vessel charter utilizing the system;

FIG. 4 is a transition chart of a display screen in the system;

FIG. 5 is a login screen in the system;

FIG. 6 is a charterer home screen in the system;

FIG. 7 is a position list screen in the system;

FIG. 8 is a questionnaire' 88 screen in the system;

FIG. 9 is an enquiry entering screen in the system;

FIG. 10 is an enquiry confirmation screen in the system;

FIG. 11 is an enquiry & indication confirmation screen in the system;

FIG. 12 is an indication entering screen in the system;

FIG. 13 is an owner's indication screen in the system;

FIG. 14 is a confirmation screen after an owner entered an indication in the system;

FIG. 15 is a negotiation room and agree screen on the owner side in the system;

FIG. 16 is a negotiation room and agree screen on a charterer side in the system;

FIG. 17 is the negotiation room and agree screen on the owner side in the middle of a negotiation step in the system;

FIG. 18 is the negotiation room and agree screen on the charterer side in the case in which one of negotiation items has reached an agreement in the system;

FIG. 19 is an agree screen when all the items in the system have been agreed upon;

FIG. 20 is the owner's indication screen in the system;

FIG. 21 is the confirmation screen after the owner entered an indication in the system;

FIG. 22 is a fixtures report screen in the system;

FIG. 23 is a negotiation screen on the owner side provided with a chat function of a vessel charter supporting system in accordance with a second embodiment;

FIG. 24 is a screen showing a state in which a message is displayed in a message display area;

FIG. 25 is a flow chart showing a flow of procedures for a vessel charter by a vessel charter supporting system in a third embodiment of the present invention;

FIG. 26 is a transition diagram of a display screen in the system;

FIG. 27 is a top page of a clean recap negotiation room on the charterer side in the system;

FIG. 28 is a top page of a clean recap negotiation room on the owner side in the system;

FIG. 29 is a negotiation starting screen of the clean recap negotiation room on the charterer side in the system:

FIG. 30 is a main term negotiation screen of the clean recap negotiation room on the charterer side in the system:

FIG. 31 is the main term negotiation screen of the clean recap negotiation room on the charterer side in the system:

FIG. 32 is a main term negotiation screen of the clean recap room on the owner side in the system;

FIG. 33 is a C/P form & other special orders negotiation screen of the clean recap negotiation room on the charterer side in the system;

FIG. 34 is the C/P form & other special orders negotiation screen of the clean recap negotiation room on the charterer side in the system;

FIG. 35 is a C/P form & other special orders negotiation screen of the clean recap negotiation room on the owner side in the system;

FIG. 36 is an on sub recap display screen after amendment by a clean recap negotiation room negotiation in the system;

FIG. 37 is a clean recap display screen in the system;

FIG. 38 is a mail attached to a clean recap transmitted to the charterer and the owner in the system;

FIG. 39 is a top page of a close preparation screen in a vessel charter supporting system in a fourth embodiment of the present invention;

FIG. 40 is a data entering screen in the close preparation screen in the system;

FIG. 41 is an entering confirmation screen in the close preparation screen in the system;

FIG. 42 is a processing selection screen in the close preparation screen in the system;

FIG. 43 is a selection screen of an owner to whom a prepare close should be disclosed in the system;

FIG. 44 is a top page of a position list update screen in a vessel charter supporting system in accordance with a fifth embodiment of the present invention;

FIG. 45 is a confirmation screen for update of a position list in the system;

FIG. 46 is an entering screen for update of a position list in the system;

FIG. 47 is a top page in a questionnaire 88 change screen of a vessel charter supporting system in accordance with a sixth embodiment of the present invention;

FIG. 48 is a questionnaire 88 change data entering screen in the system;

FIG. 49 is a flow chart showing a flow of conventional enquiry procedures of a vessel charter to be performed with the intervention of a broker; and

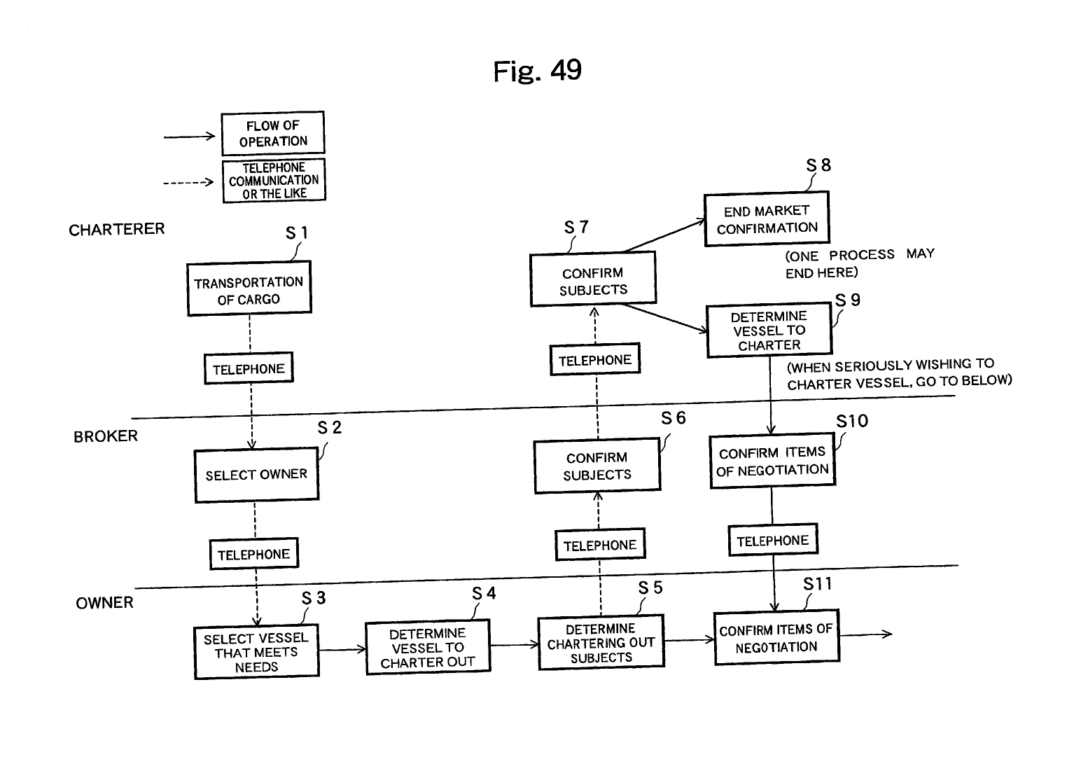

FIG. 50 is a flow chart showing a flow of the conventional enquiry procedures of a vessel charter to be performed with the intervention of a broker.

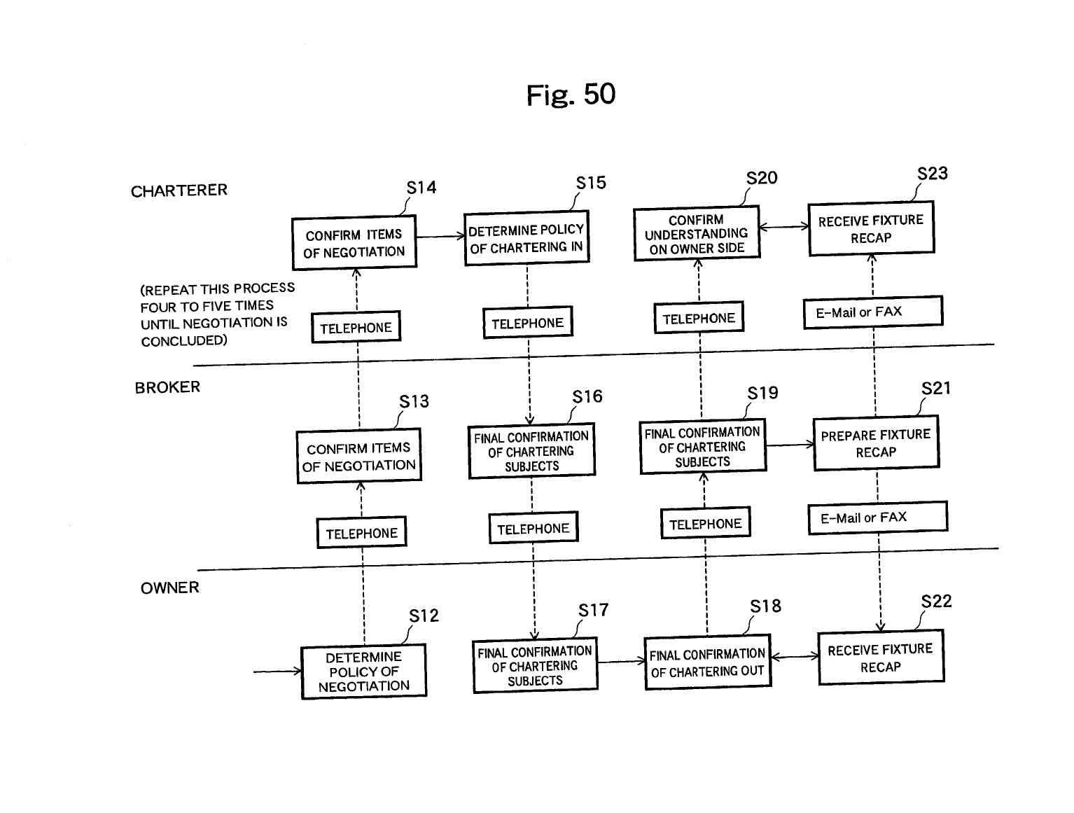

### BEST MODE FOR CARRYING OUT THE INVENTION

First embodiment

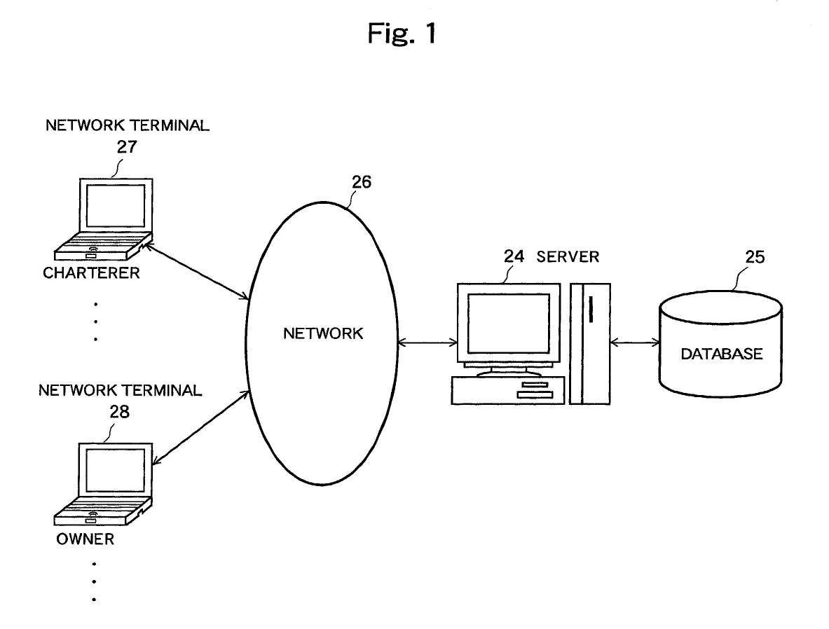

An embodiment of the present invention will be hereinafter described in detail by using FIGS. 1 to 22.

FIG. 1 is a view showing a schematic hardware configuration for realizing a vessel charter supporting system in this embodiment. A server 24 to be used in the vessel charter supporting system accumulates and manages information required for a vessel charter in database 25 and, at the same time, discloses a Web site on a network 26 such as the Internet based on accumulated information to provide a place for concluding a vessel charter for a charterer and an owner. The charterer and the owner access the above-mentioned Web site via the network 26 from respective network terminals 27 and 28 and perform a negotiation for chartering a vessel to finally conclude a vessel charter. Further, the database 25 may be accumulated and managed in the server 24 or may be accumulated in an external storage device other than the server 24 and connected to the server 24 by a network and is not limited to a form shown in FIG. 1.

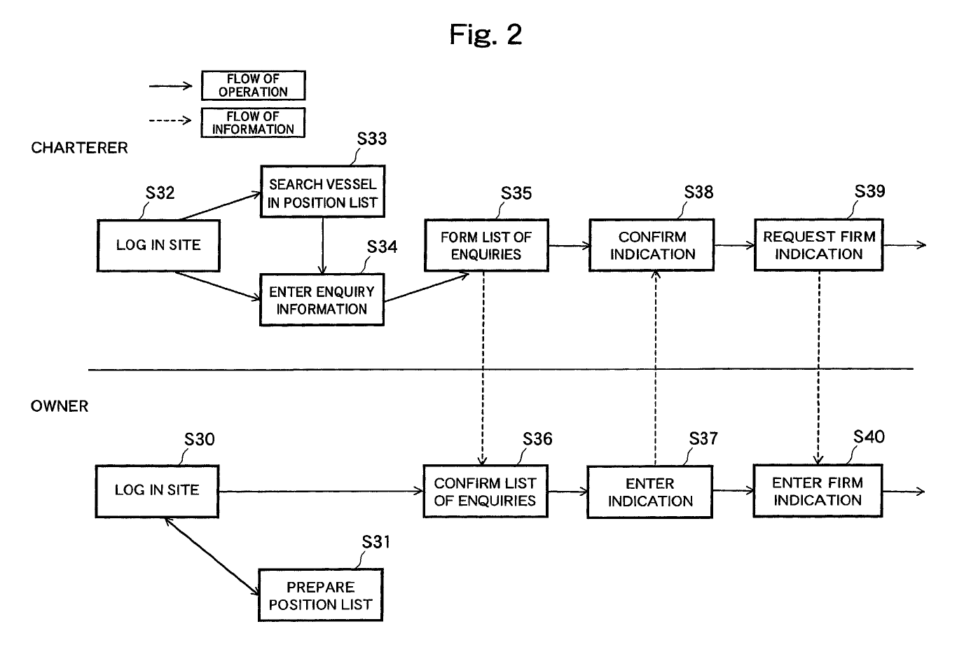

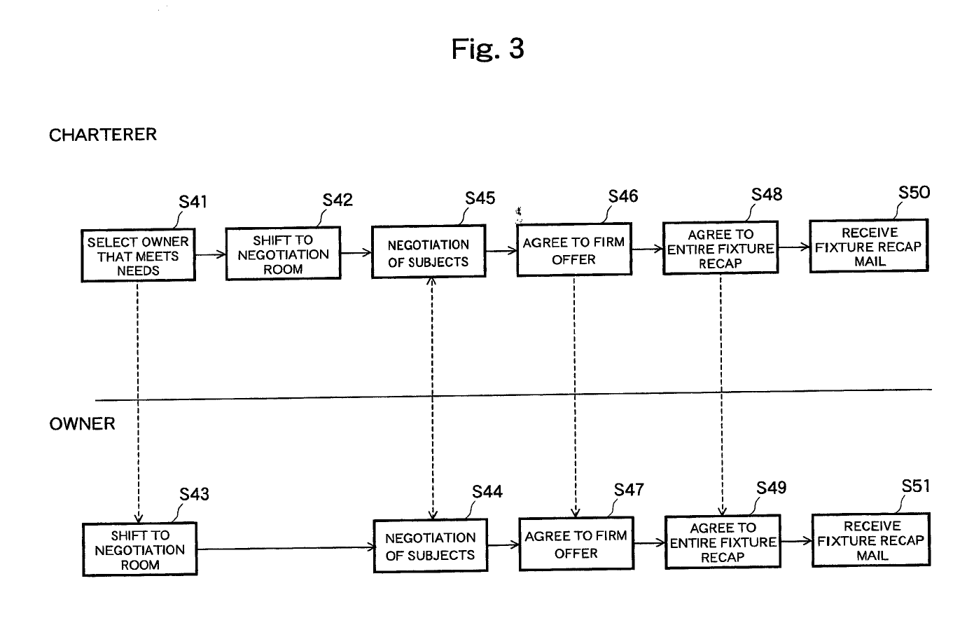

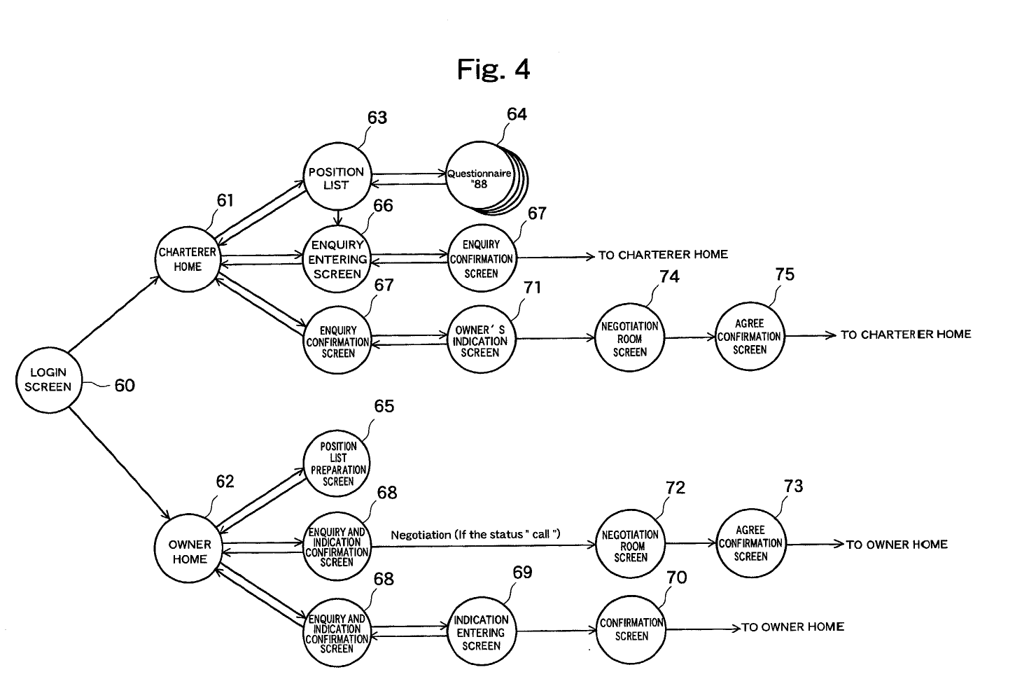

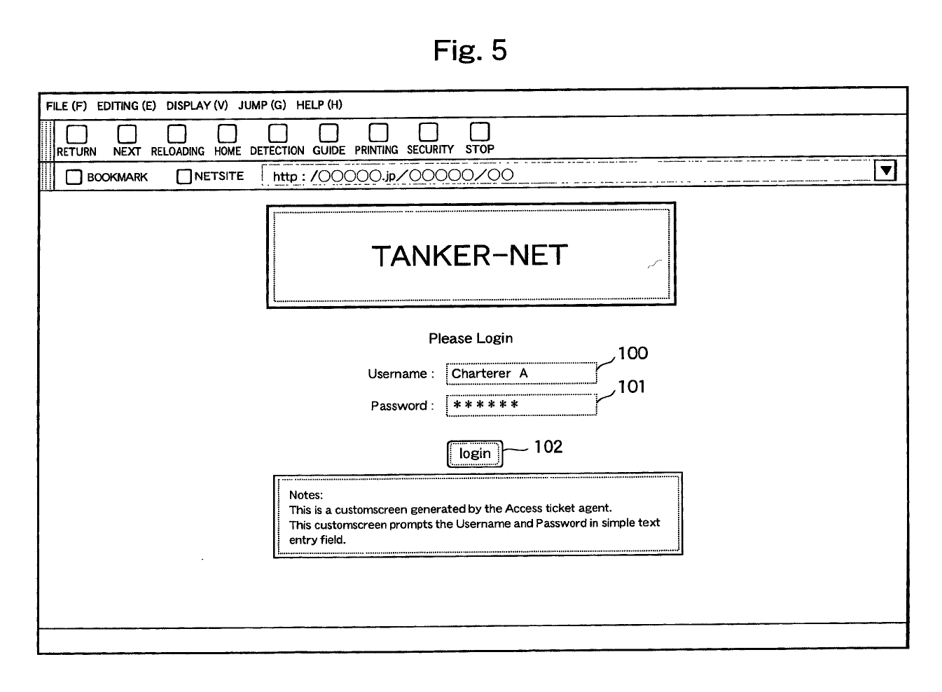

FIGS. 2 and 3 are a flow chart showing a flow of procedures for a vessel charter utilizing the vessel charter supporting system in this embodiment. Moreover, FIG. 4 is a transition diagram in this vessel charter supporting system. FIGS. 5 to 22 show an example of each screen shown in FIG. 4. Further, this embodiment refers to a vessel charter supporting system for a tanker as an example.

In this system, an enquiry for chartering a vessel is presented on a network by the network terminal 27 from the charterer side, whereby procedures are started. Further, the charterer accesses a Web site of this system established on the Internet and logs in from a login screen (FIG. 2, S32). The login screen corresponds to a login screen 60 in FIG. 4, and FIG. 5 shows an example of the screen. The charterer enters a user name (Username 100) and a password (Password 101) and clicks a login button 102 to log in this system.

Further, the login screen 60 not only functions as the login screen for the charterer but also functions as a login screen for the owner in this embodiment and determines whether the system side is the charterer or the owner from entered user name and password in this embodiment. As shown in FIG. 4, the login screen 60 changes to a charterer home screen (Charterer Home) 61 or an owner home screen (Owner Home) 62 based on a result of the determination.

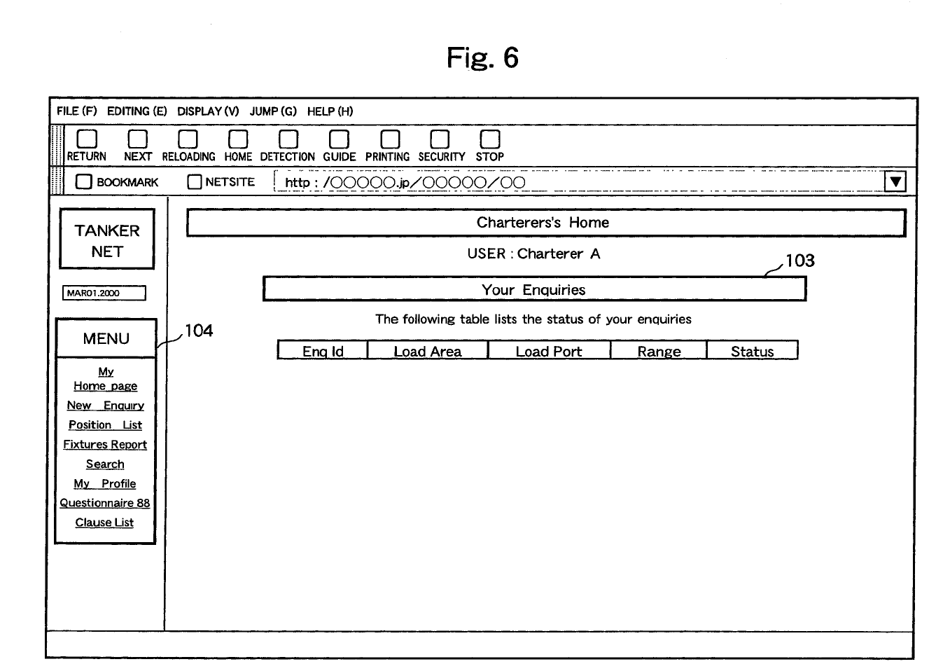

An example of the charterer home screen 61 is shown in FIG. 6. In the figure, the charterer home screen 61 is shown in case of a user name “Charterer A” in the figure, and this screen also functions as an enquiry confirmation screen 67 to be described later and, if an enquiry of a vessel entered by the charterer before exists, its contents are displayed as a list in a part below the characters “Your Enquiries” 103 shown in FIG. 6. If an enquiry does not exist, the part becomes blank as shown in FIG. 6.

The charterer having logged sends an enquiry for chartering a vessel to the owner side in the Web site. There are two patterns for making an enquiry, namely, a pattern in which the charterer specifies a required vessel in advance and sends an enquiry only to an owner of the vessel and a pattern in which the charterer presents subjects of a required vessel and invites a plurality of owners to tender for a vessel meeting the subjects. The former pattern will be described first.

The charterer usually determines a vessel for which the charterer sends an enquiry based on information of vessels registered in the database 25 of this system. The confirmation of information on vessels and the determination of a vessel are performed in a position list screen 63 (FIG. 4) in FIG. 4 (FIG. 2, S33).

The charterer clicks a “Position List” in menu items 104 of the left frame in FIG. 6 to call a position list screen 63. Further, the menu items 104 are always displayed on screens other than that in a negotiation stage after the charterer logs in.

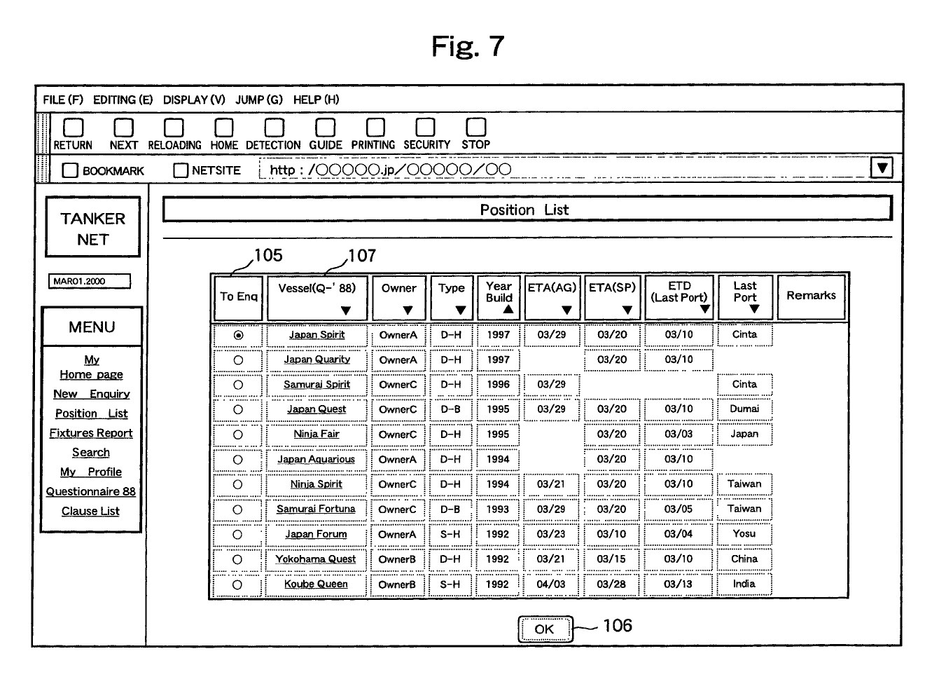

An example of the position list screen 63 is shown in FIG. 7. An outline of the information of vessels stored in the database 25 is displayed on the position list screen 63. In FIG. 7, a vessel name (Vessel), an owner name (Owner), a type of a vessel (Type), a year of building a vessel (Year Build), an estimated time of arrival in the Arabian Gulf (ETA (AG)), an estimated time of arrival in Singapore (ETA (SP)), a estimated time of departure from a last port (ETD (Last Port)), a name of a last port (Last Port), and remarks (Remarks) are displayed as a list from the left. Characteristics and position information of each vessel registered in the database 25 can be grasped according to the information. Further, the above-mentioned ETA is the abbreviation of Estimated Time of Arrival and ETD is the abbreviation of Estimated Time of Departure.

In addition, the charterer sets and enters predetermined subjects from an information terminal about an outline of information of vessels shown in the position list, whereby the charterer can select vessels meeting the predetermined subjects out of the vessels to be displayed in the position list and display it. By performing such selection display, it becomes possible to find a desired vessel easily. As the predetermined subjects, there are, for example, a year of building a vessel, an estimated time of arrival or an estimated time of departure, or ranges of these dates. More specifically, for example, there are vessels built “in or after 1990” as subjects for Year Build or vessels in the range of “May 1 to May 5” as subjects for ETA SP.

Moreover, an option button (To Enq.) 105 is provided in the left of the list, and the charterer can select a vessel for which the charterer sends an enquiry by checking this option button 105. In FIG. 7, a vessel named “Japan Spirit” of an Owner A is selected. When the charterer clicks an OK button 106 in this state, an enquiry is sent for the vessel named “Japan Spirit” of the Owner A.

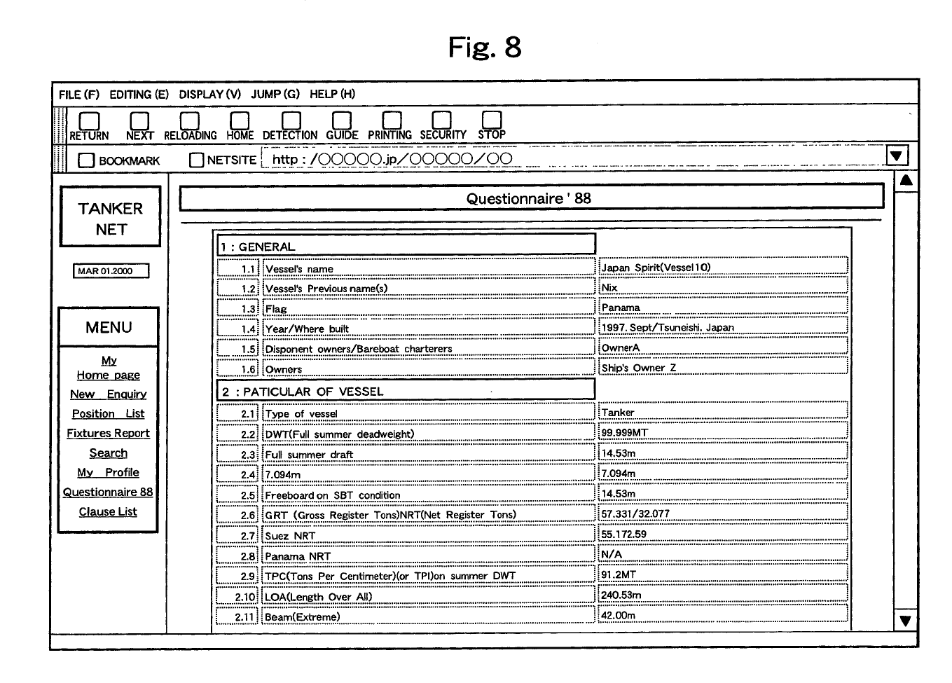

In addition, in this embodiment, the charterer clicks any one of vessel names 107 in the list, whereby a Questionnaire' 88 screen 64 in FIG. 4 is displayed, in which detailed information concerning the clicked vessel is further provided to the charterer side. An example of display on the Questionnaire' 88 screen 64 in the case in which the vessel name “Japan Spirit” in FIG. 7 was clicked is shown in FIG. 8. The charterer refers to this screen before clicking the above-described OK button 106, whereby it becomes possible to select a vessel that matches a need better. Further, although not shown, an enquiry can be sent for a vessel displayed on the Questionnaire' 88 screen as in the position list screen in this system. By establishing a convenient system in this way, the charterer can sends an enquiry easily and quickly.

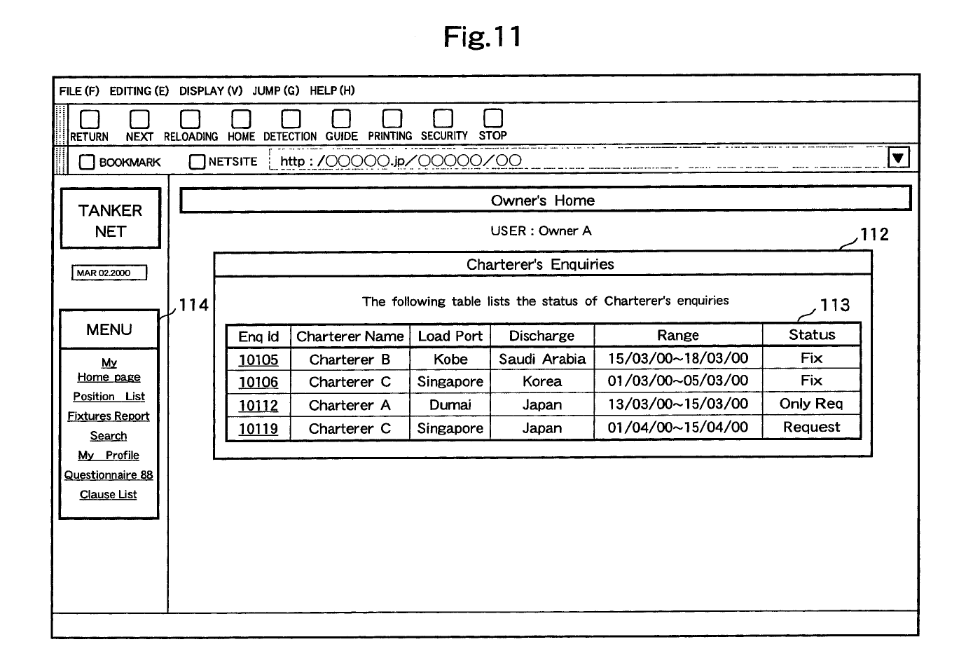

Further, the above-mentioned position list is separately entered and prepared by the owner side in advance. The owner logs in the Web site of this system (FIG. 2, S30) and then clicks “Position List” in menu items (not shown but similar to menu items 114 in FIG. 11) of the left frame of the owner home screen 62 to call the position list preparation screen 65 in FIG. 4 and entering information of a vessel of the owner (FIG. 2, S31). Further, the menu items are always displayed on screens other than that in the negotiation stage after the owner logs in. In addition, although an example of display on the position list preparation screen 65 is not shown, it is also possible to leave a position that the owner does not wish to disclose blank. Further, update of the position list will be described in a fifth embodiment to be described later. In addition, it is also possible to enter and change the Questionnaire' 88 in the same manner. Change of the Questionnaire' 88 will be described in a sixth embodiment to be described later.

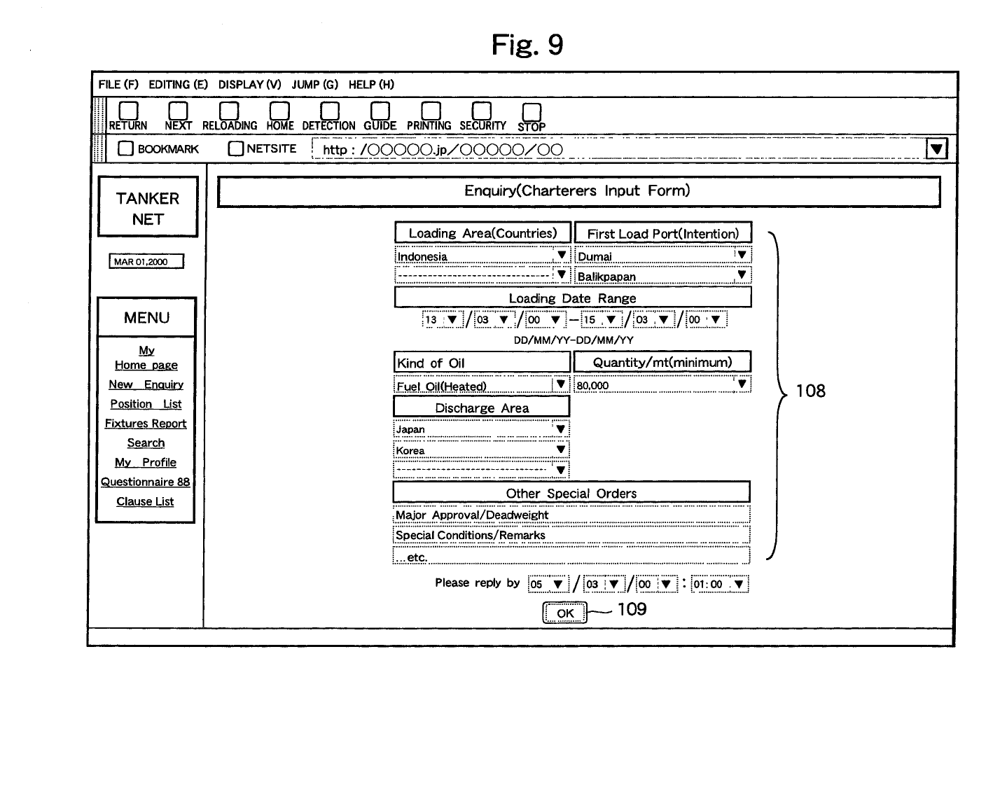

When a Charterer A determines a vessel for which the charterer sends an enquiry on the position list screen 63, an entering screen (Enquiry entering screen) 66 (FIG. 4) for entering contents of an enquiry to the owner “Owner A” is displayed. An example of display on the enquiry entering screen 66 is shown in FIG. 9. As entering items 108, there are a desired loading area (Loading Area), a desired loading port (First Load Port), a desired period of loading (Loading Date Range), a kind of load (Kind of Oil), a quantity of loads (Quantity/MT), a desired discharge area (Discharge Area), other subjects (Other Special Orders) and a valid period of the enquiry (Please Reply by), almost all the items are pull-down menus in order to make an entering easy.

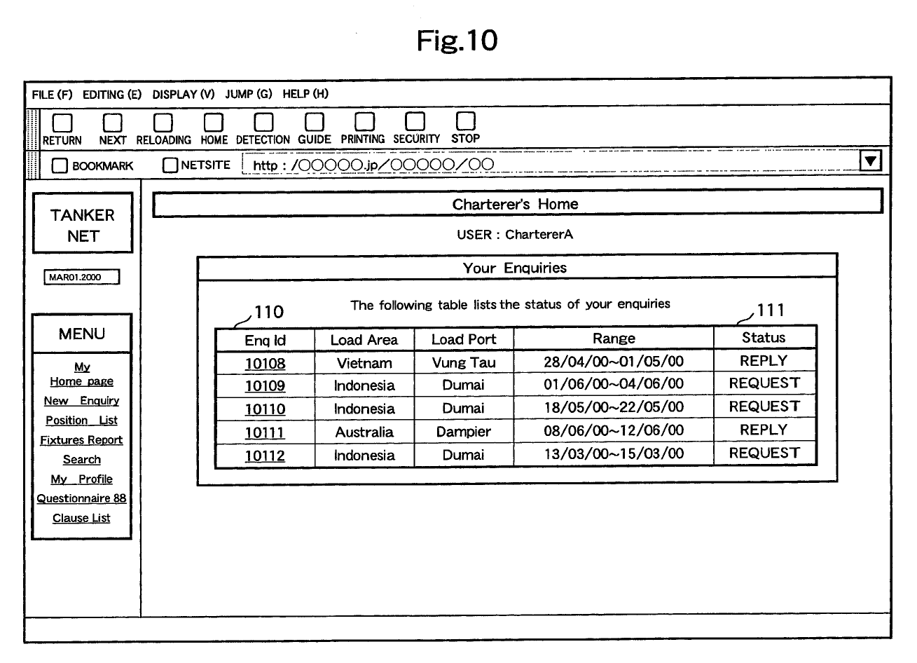

When the Charterer A clicks an OK button 109 after entering an item in the enquiry entering screen 66, the system side assigns an ID for the enquiry and displays an enquiry confirmation screen 67 (FIG. 2, S35). An example of display on the enquiry confirmation screen 67 is shown in FIG. 10.

The Charterer A confirms an entered enquiry on the enquiry confirmation screen 67 of FIG. 10. The enquiry entered on the above-mentioned enquiry entering screen 66 is listed as an enquiry ID “10112” in an Enq ID items 110 in FIG. 10. Further, enquiries for chartering vessels entered by the Charterer A in the past are also displayed in the list, what kind of statuses the enquiries are at present can be confirmed in a Status item 111 on the right side of the list. In this embodiment, the statuses of the enquiries are represented by characters such as Reply (received an indication from the owner), Request (presented an enquiry but received no indication from the owner), Call (negotiation stage) and Fix (concluded a vessel charter).

In this way, when the Charterer A sends an enquiry, the owner “Owner A” can confirm the enquiry on the network (S36). This confirmation screen is an enquiry & indication confirmation screen 68 in FIG. 4 and its example of display is shown in FIG. 11. FIG. 11 is the owner home screen 62 in case of the user name “Owner A”, which also functions as the enquiry & indication confirmation screen 68 of the Owner A, and if an enquiry for chartering a vessel to the Owner A exists, its contents are shown as a list in a part below the characters “Charterer's Enquiries” 112 shown in FIG. 11. If an enquiry does not exist, the part becomes blank. Further, in FIG. 11, the enquiry ID “10112” sent by the above-mentioned Charterer A is displayed.

In addition, a status of the enquiry can be confirmed in “Status” items 113 on the right side of the list, and the status is represented by the characters such as Reply (replied to the charterer), Request (not replied to an enquiry from the charterer), Call (negotiation stage) and Fix (concluded a vessel charter) as in the enquiry confirmation screen 67 on the charterer side. Moreover, the characters “Only Req.” indicating that an enquiry is an enquiry for vessels owned or operated by the Owner A are shown in the “Status” items in the enquiry of the enquiry ID “10112” of this time. Further, a difference between “Request” and “Only Req.” is whether the enquiry from the charterer is a pattern of public invitation or a pattern of an enquiry directed only to the charterer. An enquiry in case of public invitation will be described later.

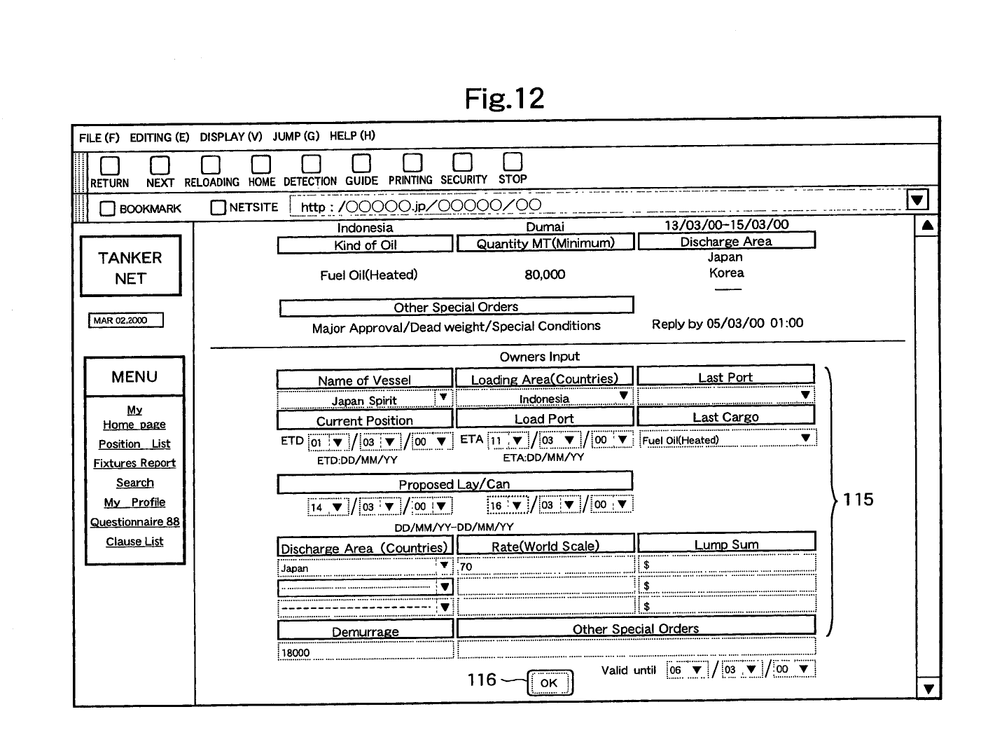

If the “Status” item 113 is “Request” or “Only Req.”, when the Charterer A clicks the enquiry ID, an indication entering screen 69 in which the owner enters an indication to the enquiry is displayed as shown in FIG. 4. An example of display on the indication entering screen 69 with respect to the above-described enquiry ID “10112” is shown in FIG. 12. The information that the Charterer A entered on the enquiry entering screen 66 is displayed as it is in the upper part of FIG. 12 and a form for the owner to enter is shown below it.

If the owner is interested in the enquiry from the charterer shown in the upper part of the drawing, the owner enters each item 115 of the entering form and reply to the charterer. Further, as entering items, a name of a vessel (Name of Vessel), a desired loading area (Loading Area), a departing port (Last Port), an estimated time of departure (ETD Last Port), an estimated time of arriving at loading area (ETA Load Port), a kind of a last cargo (Last Cargo), an available period of loading (Proposed Lay/Can), a discharge area (Discharge Area), a vessel charter rate (World Scale, Lump Sum), a demurrage per one day (Demurrage), other subjects (Other Special Orders) and a valid period of the indication (Valid until) are shown in the drawing.

When the Owner A enters all the items on the indication entering screen 69 and presses an OK button 116, an indication is transmitted to the Charterer A. After the indication is transmitted, the processing returns to the owner home screen 62 (FIG. 2, S37). At this point, Reply is displayed (not shown) instead of Only Req. in the Status 113 of the enquiry ID “10112” in the list displayed on the enquiry & indication confirmation screen 68 of FIG. 11.

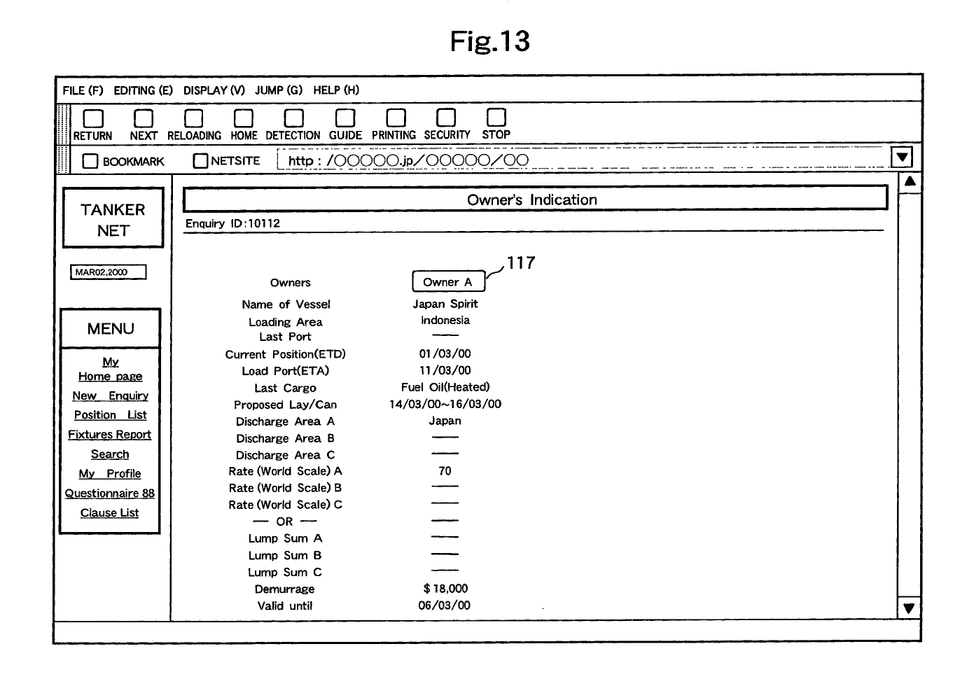

When the Charterer A receives the indication from the Owner A, Reply is displayed (not shown) instead of Request in the Status 111 of the enquiry ID “10112” in the enquiry confirmation screen 67 of FIG. 10. Here, the Charterer A clicks the enquiry ID “10112” to display an owner's indication screen 71 and confirm the indication from the owner A (FIG. 2, S38). An example of display on the owner's indication screen 71 is shown in FIG. 13.

On the owner's indication screen 71, if the charterer is interested in the indication from the owner, the charterer clicks a button of an owner's name (“Owner A” button 117 in FIG. 13), thereby further requesting the owner a firm indication (formal offer for provision of a vessel) (FIG. 2, S39). Further, if an enquiry sent by the charterer has more sense of a market research or if the charterer has lost the interest in the indication, the charterer naturally ends the enquiry at this point without requesting a firm indication to the owner.

When the Owner A receives a request for firm indication from the Charterer A, the Status item 113 of the enquiry & indication confirmation screen 68 (similarly as FIG. 11) of the Owner A changed to a display like “F/Request” and the owner shifts to the firm indication entering screen by clicking the enquiry ID.

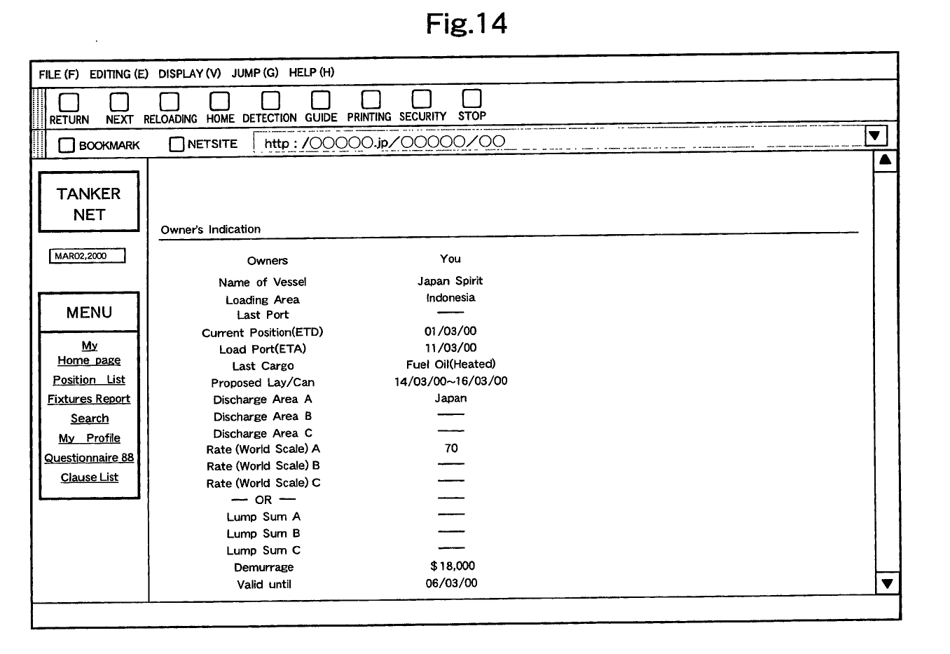

Further, the firm indication entering screen equals to the indication entering screen 69. The Owner A repeats processing similar to that in the above-described S37 as a formal indication again in the entering screen (FIG. 2, S40). Further, after the indication and the firm indication are entered, a confirmation screen 70 as shown in FIG. 14 is displayed and it is possible for the owner to confirm items entered by it. In addition, the confirmation screen 70 can be inspected at any time by clicking the enquiry ID of the enquiry & indication confirmation screen 68.

The Charterer A having confirmed the firm indication from the Owner A as in the above-described S38 clicks a button of an owner name (Owner A 117) in FIG. 13 again to enter a negotiation stage for a vessel charter with the owner (FIG. 3, S42). Further, processing of S41 of FIG. 3 is not performed in case of an enquiry as in this example that utilizes the position list but only performed in case of a public invitation to a plurality of owners to be described later.

When the Charterer A enters the negotiation stage, the Status item of the enquiry & indication confirmation screen 68 on the Owner A side changes to “Call”. At this stage, when the confirmation screen of FIG. 14 is displayed again, a button of “Negotiation” is displayed in a part below it (not shown) and, when it is clicked, the charterer shifts to a screen for a negotiation (FIG. 3, S43).

In addition, since a negotiation with the Charterer A is surely performed even in a state in which the Owner A has not logged in this Web site, an electronic mail to the effect that the enquiry has entered the negotiation stage is automatically transmitted to the Owner A from this system simultaneously with the Charterer A entering the negotiation stage. A message of the electronic mail includes a URL of the Web site of this system, and the owner can move to the screen for a negotiation simply by clicking the URL.

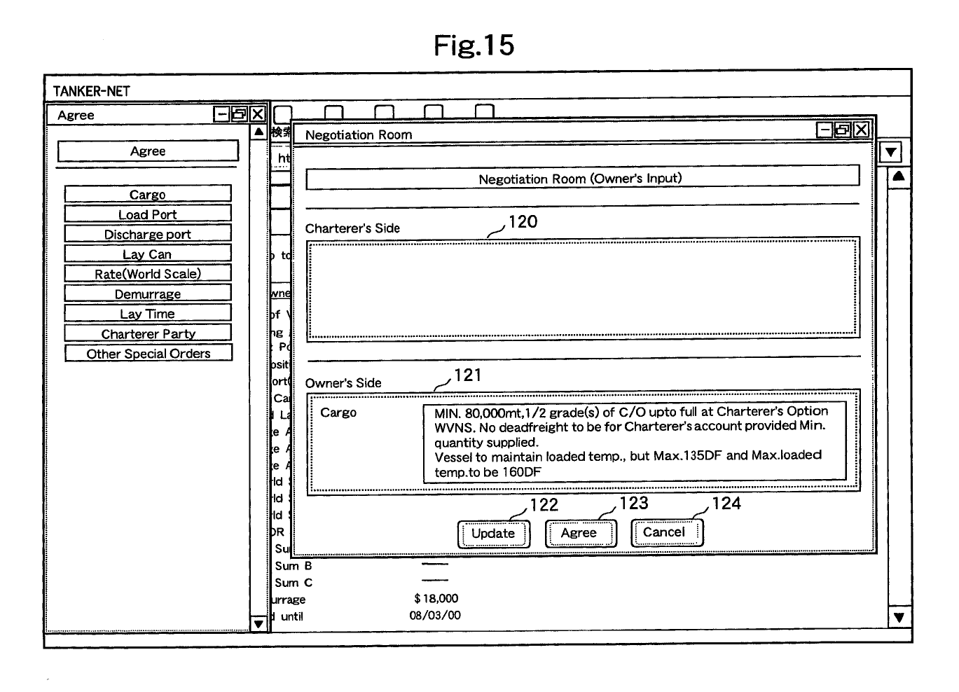

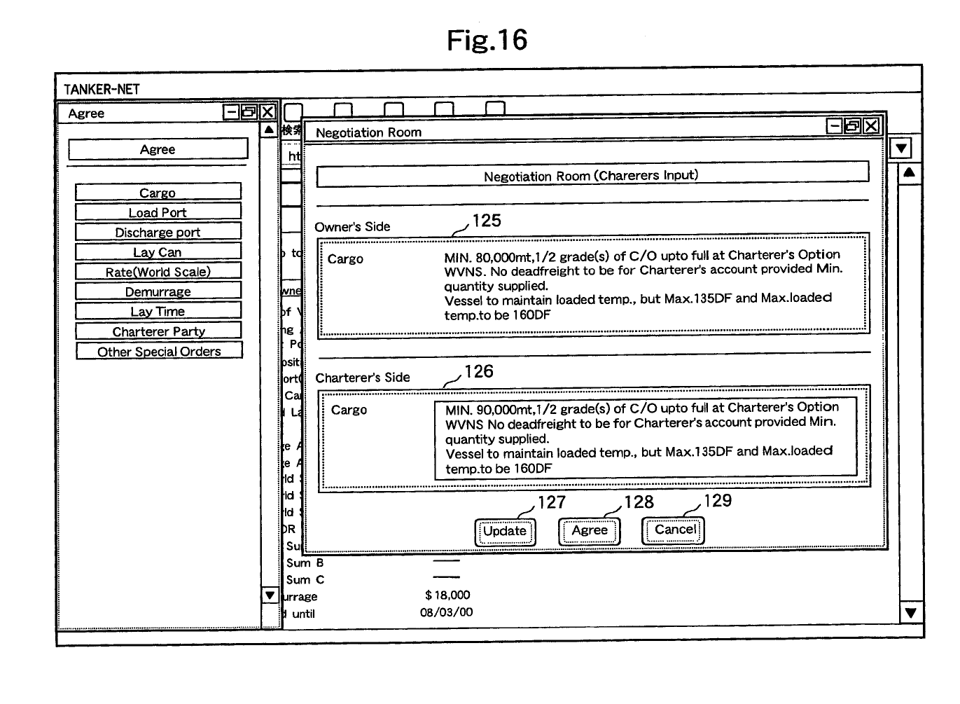

When a negotiation (Negotiation Room) screen 72 in FIG. 4 is displayed on the owner side, another pop-up window (FIG. 4, Agree screen 73) in which negotiation items are shown is displayed on the left side at the same time. An example of display of the Negotiation Room and the Agree screen is shown in FIG. 15. In addition, when the charterer side also enters the negotiation stage, a negotiation (Negotiation Room) screen 74 and another pop-up window (FIG. 4, Agree screen 75) in which negotiation items are shown are displayed as shown in FIG. 4. An example of the display is shown in FIG. 16. Further, in this embodiment, both the Negotiation Room screens and the Agree screens of the charterer and the owner are displayed as one screen and are associated with each other to operate.

Further, in the Negotiation Room screen 72 of the owner in FIG. 15, a Charterer's Side 120 in the upper part is a display area for displaying subjects transmitted from the charterer and an Owner's Side 121 is an entering area in which the owner itself enters subjects.

Similarly, in the Negotiation Room screen 74 of the charterer in FIG. 16, an Owner's Side 125 in the upper part is a display area for displaying subjects transmitted from the owner and a Charterer's Side 126 is an entering area in which the charterer itself enters desired subjects for a pertinent item. In this negotiation screen, the owner and the charterer proceed with a negotiation in the order of negotiation items displayed on the left side and agree upon the items. Simultaneously with agreeing upon the items, contents of the agreement are sequentially displayed immediately below each negotiation item name of the Agree screens 73 and 75 of both of them.

An example until each item is agreed upon will be hereinafter described.

First, the Owner A side enters subjects for a cargo being a first negotiation item in a predetermined entering area. In FIG. 15, desired subjects for the cargo have already been entered in an entering area of an Owner's Side 121 of the Negotiation Room screen 72 by the owner and, when a button of Update 122 is clicked in this state, the entered contents are transmitted to the Charterer A side and the subjects entered by the Owner A are displayed as they are in a display area of an Owner's Side 125 of the Negotiation Room screen 74 on the charterer A side in FIG. 16. Moreover, the contents entered by the Owner A side are also displayed in an entering area of a Charterer's Side 126 in the same manner, and this area is editable and it is possible to arbitrarily add an amendment if the charterer cannot agree to the subjects presented by the owner side.

At this point, if the Charterer A side cannot agree to the subjects presented by the Owner A side, the charterer add change in an entering area of a Charterer's Side 126 to transmit desired subjects to the Owner A side (FIG. 3, S45). In addition, if the Charterer A side agrees to the subjects presented by the Owner A, the charterer clicks an Agree button 128 (FIG. 3, S46).

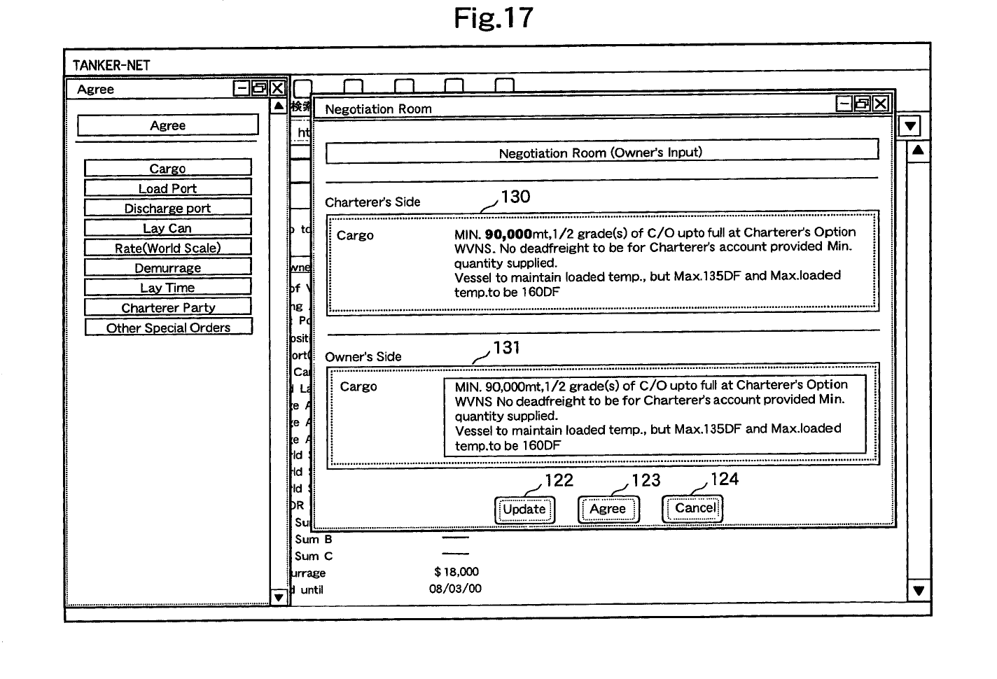

To describe the former case more in detail, when the charterer adds change to subjects of loading transmitted from the owner side in an entering area of the Charterer's Side in the lower part of the Negotiation Room screen 74 in FIG. 16 (already in a changed state in FIG. 16) and clicks an Update button 127, the subjects are in turn transmitted to the owner side and the contents entered by the Charterer A are displayed as they are in the display area of the Charterer's Side 120 of the Negotiation Room screen 72 on the owner side of FIG. 15. At this point, the changed parts are displayed in bold or colored characters to be clearly distinguished. An example of its display is shown in FIG. 17.

At this point, if the Owner A side cannot agree to the subjects presented by the Charterer A side, the Owner A further adds change in an entering area of an Owner's Side 131, clicks the Update button 122 to transmits subjects to the Charterer A side and continues the negotiation (S44, FIG. 3). To the contrary, if the Owner A side is satisfied with the subjects presented by the Charterer A, the Owner A clicks an Agree button 123 (S47, FIG. 3). Further, to cancel an entered item, a Cancel button 124 is clicked.

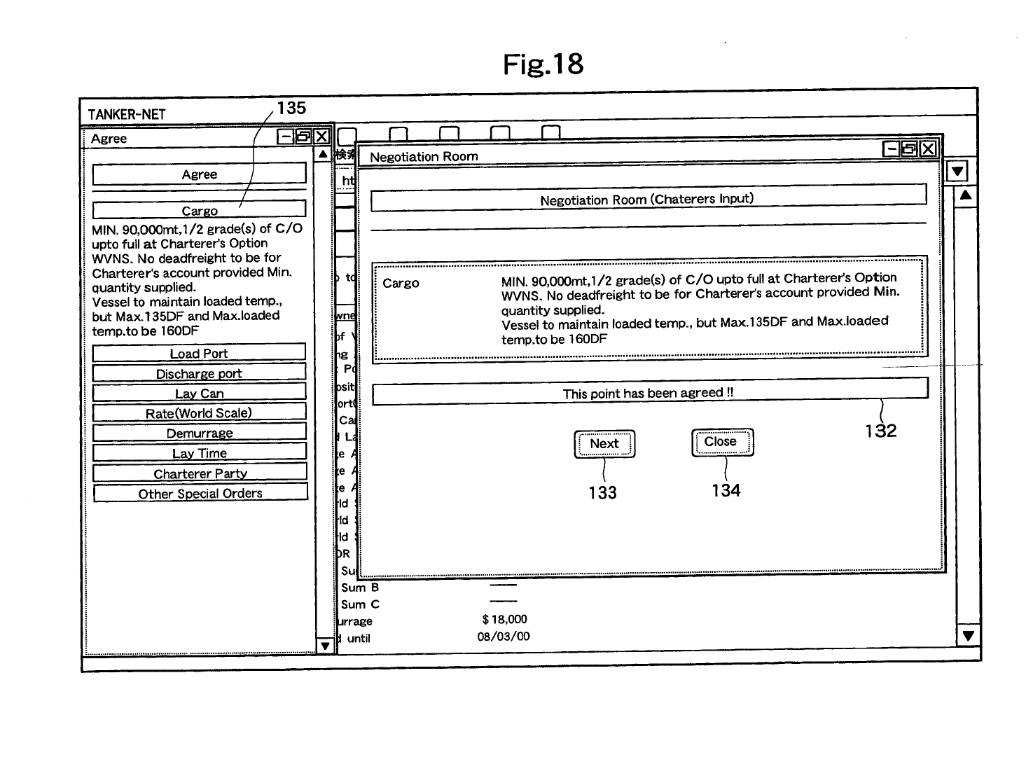

Assuming that the Owner A clicks the Agree button at this point, agreed contents are displayed immediately below a Cargo item 135 of an Agree screen 75 on the Charterer A side as shown in FIG. 18. Moreover, characters like “This point has been agreed.” 132 are displayed on the screen to clearly indicate that the negotiation item has been agreed upon. Moreover, a Next button 133 and a Close button 134 are displayed in the lower part of the screen, with which the charterer can select whether to further continue or discontinue the negotiation. Further, a screen on the owner side when an agreement is reached is displayed in the same manner as on the charterer side.

When the charterer clicks the Next button 133, the charterer can proceed with a negotiation about the next items displayed on the Agree screens 73 and 75, a loading area (Load Port) and a discharge area (Discharge Port) as in the Cargo item (S44 to S47). If the charterer clicks the Close button 134, the negotiation is once discontinued. In this system, since all logs of the negotiation contents are recorded, it is possible to resume from a discontinued item even if the negotiation is discontinued.

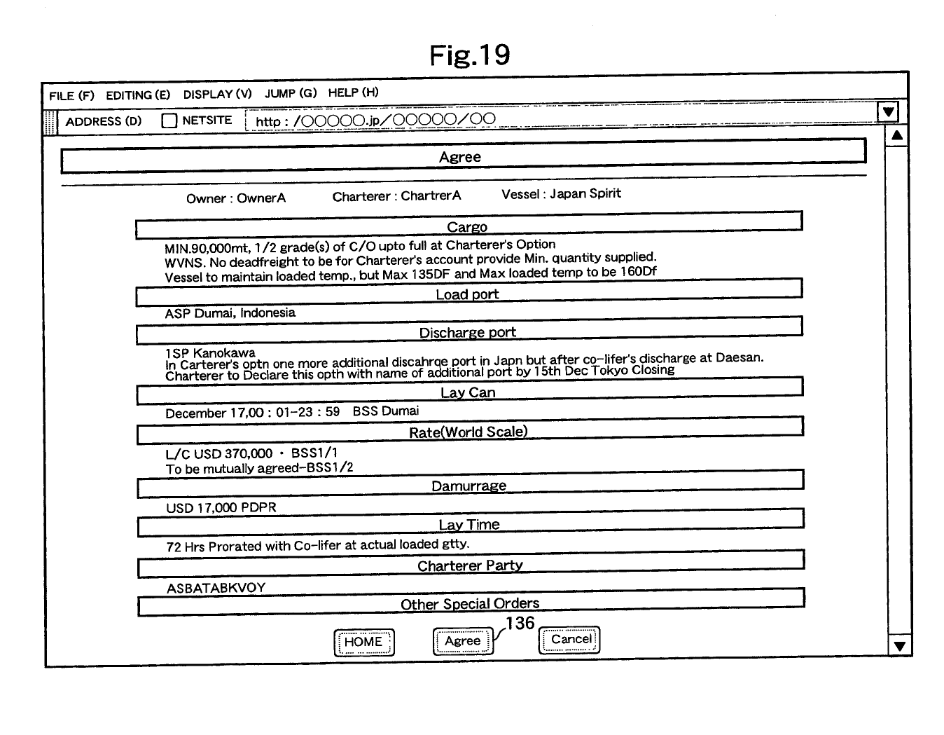

When the charterer and the owner agree upon all the items, the Agree screens 73 and 75 are in a state in which all contents of the agreement on each item are displayed. The charterer and the owner finally confirm this as a fixture recap. An example of its display is shown in FIG. 19. The illustrated Agree screen is enlarged for ease of confirmation. Here, both of them click the Agree button 136 shown in the lower part of the screen, whereby a vessel charter is concluded (S48 and S49, FIG. 3).

When the charter is concluded, this system automatically transmits the fixture recap on the Agree screen to both the Charterer A and the Owner A separately. Therefore, it becomes possible to confirm the fixture recap without accessing the Web site of this system after the charter is concluded (S50 and S51, FIG. 3). In addition, display of a status of the pertinent ID changes to “Fix” in enquiry confirmation screen 67 of the charterer (FIG. 10) and the enquiry & indication confirmation screen 68 of the owner (FIG. 11) simultaneously.

As described above, although a case in which a charterer selects a desired vessel in a position list in advance and sends an enquiry only to an owner of the vessel has been described, a system may be established with which an owner to which an enquiry is sent is not limited to one but can be sent to several owners preferred by the charterer at the same time. In this case, if a screen on which a plurality of vessels or vessel companies preferred by the charterer can be designated to enable the charterer to easily select a desired vessel or vessel company by an option button such as the To Enq. 105 shown in the position list of FIG. 7, the system becomes more convenient for the charterer (not shown).

Next, details of procedures of a vessel charter in a case in which only subjects of a desired vessel is presented without designating an owner or a vessel and tenders for vessels conforming to the subjects are publicly invited from a plurality of owners will be described. However, it is needless to mention that a basic flow of procedures does not change.

In FIG. 2, after the charterer logs in the Web site in order to send an enquiry (S32), the charterer clicks “New Enquiry” from the menu items 104 of the left frame in FIG. 6 to call the enquiry entering screen 66. The charterer does not call a position list. An example of display of the enquiry entering screen 66 is the same as that in the above-described FIG. 9. In addition, the charterer enters the entering items in the same manner as described above (S34). When the charterer clicks the OK button 109 after entering the items, the system side assigns an ID to the enquiry and forms a list in the enquiry confirmation screen (FIG. 10) of S35 and at the same time automatically sends an enquiry to owners that own or operate vessels meeting subjects entered by the charterer based on a database linked to this system.

When the charterer sends an enquiry in this way, each pertinent owner can confirm the enquiry using the enquiry & indication confirmation screen 68 (FIG. 11) as in the above-described S36 on the network. Characters “Request” indicating that the enquiry is a public invitation are displayed in the Status item 113 concerning the enquiry of the enquiry ID sent by the charterer. Here, when the owner clicks the enquiry ID having a status of “Request”, an indication entering screen 69 with which the owner enters an indication with respect to a vessel for the enquiry to the charterer is displayed. The example of display is the same as that in the above-described FIG. 12 and the entering is performed in the same manner (S37).

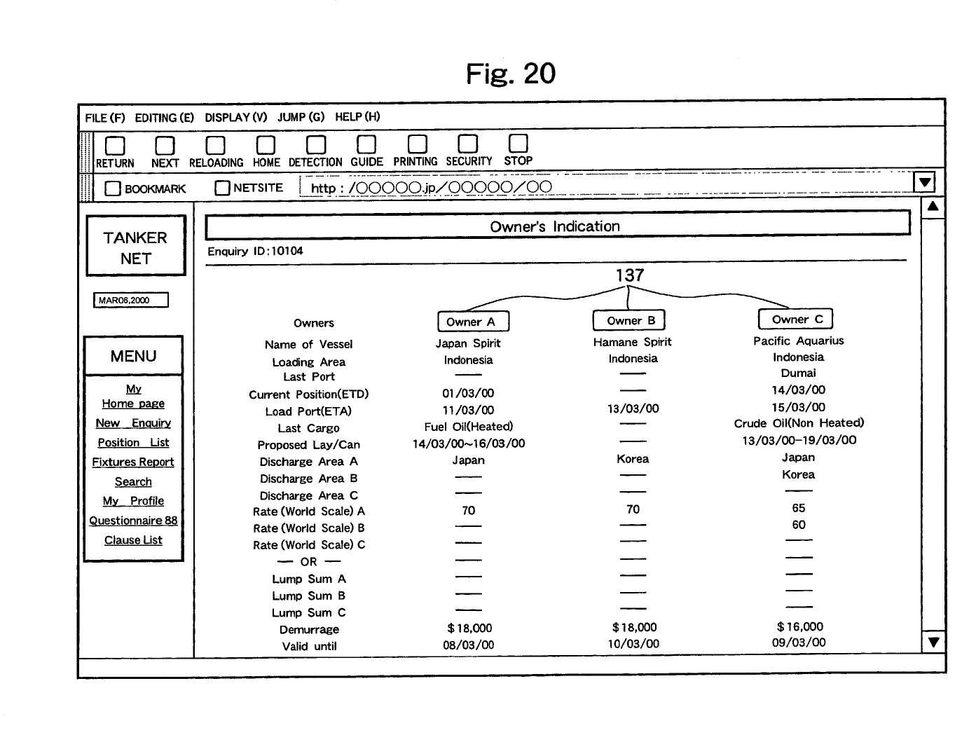

Upon receiving an indication from the owner, the charterer causes the system to display the owner's indication screen 71 in the same manner as described above and confirms the indication (S38). In this example, since the enquiry is a public invitation, indications come from a plurality of owners. Thus, each indication is displayed side by side on the owner's indication screen 71 as shown in FIG. 20. With such a display method, it becomes easy for the charterer to compare and examine subjects from each owner.

Here, if the charterer sees an indication from an owner and becomes interested in it, the charterer clicks a button 137 of a name of the owner the charterer is interested in, thereby further requesting a firm indication (formal offer to provide a vessel) to the pertinent owner (S39). It is needless to mention that firm indications may be requested to a plurality of owners. The charterer sees firm indications from the plurality of owners (S40) to select an owner of a vessel with good subjects (S41) and advances to a negotiation (S42).

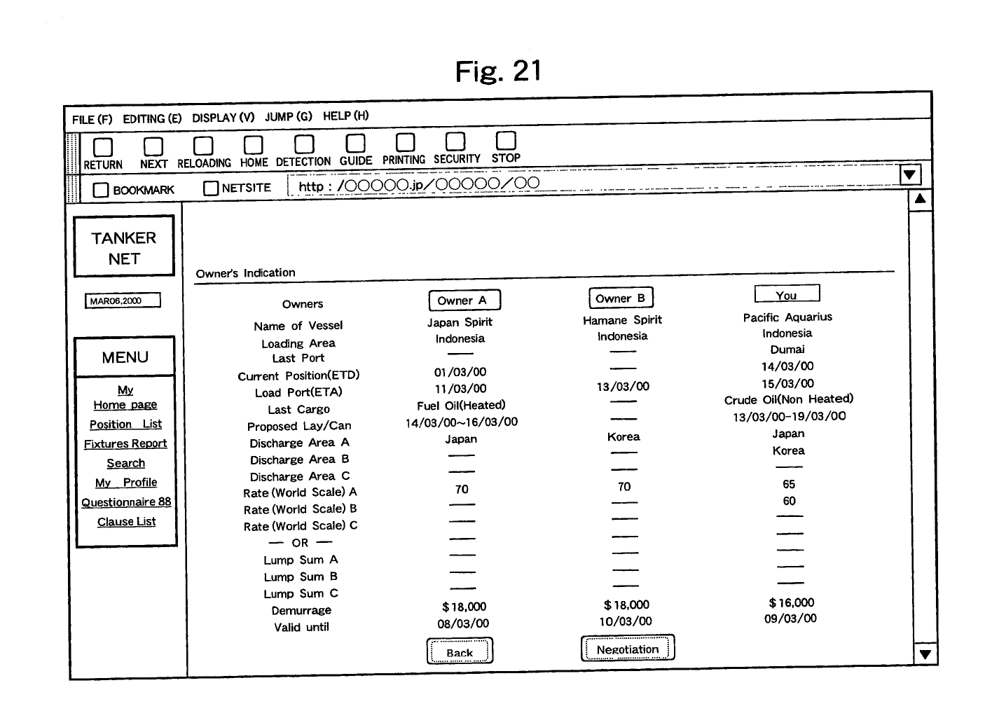

Further, after the owner enters an indication and a firm indication (S37, S39), the confirmation screen 70 is displayed and the owner can confirm items that the owner itself entered. In the case of this example, since the enquiry is a public invitation, subjects of competitors are also displayed on the confirmation screen to enable the owner to learn subjects presented by other companies. An example of its display is shown in FIG. 21. In addition, the owner can inspect the confirmation screen 70 at any time by clicking the Enquiry ID of the enquiry & indication confirmation screen 68.

Further, the display method may be arranged such that only items that an owner itself entered are displayed on the confirmation screen to the end and subjects presented by other companies are not displayed. With such a display method, owners can proceed with negotiations with a charterer without other companies knowing each other's subjects.

Moreover, if the charterer selects an owner with which the charterer wishes to have a negotiation in S41 in this system, the charterer clicks the button 137 of the desired owner's name out of displayed owners' names on the owner's indication screen 71 of FIG. 20. Then, the charterer enters a negotiation stage with the clicked owner and the same procedures are performed until conclusion of a vessel charter.

Further, since not only a log during a negotiation but also contents of all vessel charters are recorded in the embodiment of the present invention, it becomes possible to call contents of charters concluded in the past and use them again. The contents of charters concluded in the past can be called by clicking an ID that has a status display “Fix” on the enquiry confirmation screen 67 of the charterer and the enquiry & indication confirmation screen 68 of the owner.

Moreover, entering of both Indication and Firm Indication are made essential in a stage before entering a negotiation in the above-described system. As another embodiment, the system may be a system in which an owner can select any one entering of Indication (offer that can be cancelled) or Offer (formal offer) and, if any one of them is entered, can proceed to a stage of a negotiation by an indication from the charterer next. In this way, the system becomes quick and convenient to use.

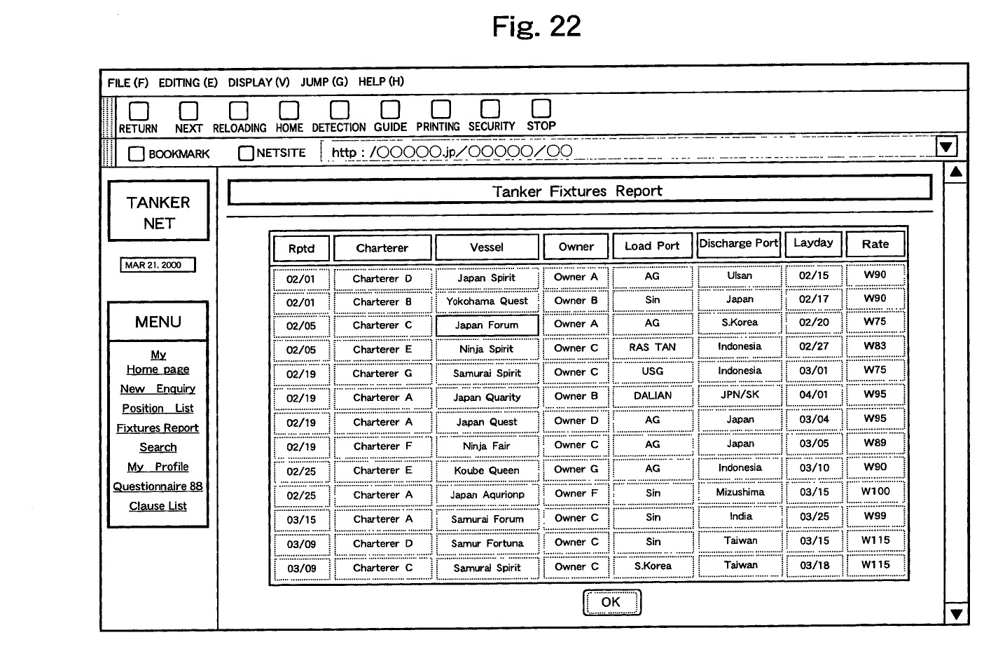

Further, in the embodiment of the present invention, it is possible for an owner and a charterer to inspect all summaries of contents of charters in the past accumulated in a database arranged in a list as histories. This screen can be called by clicking “Fixtures Report” to be shown in menu items of the left frame of menu items on an owner and charterer home screens. An example of its display is shown in FIG. 22. (It is not shown in the screen transition diagram of FIG. 4.) Rates in agreements concluded in the past are displayed on this list and serves as a price index (price list). Both the owner and the charterer refer to this list, whereby a negotiation conscious of a market price can be developed and it becomes possible to conclude a charter smoothly.

Second embodiment

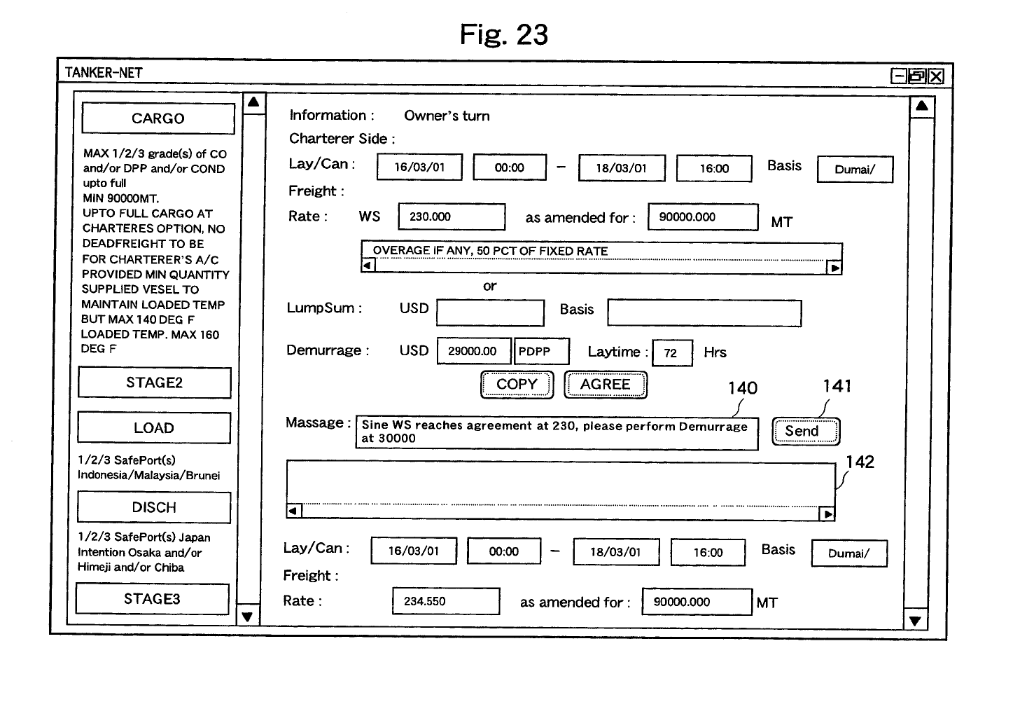

In the negotiation screen of the above-mentioned first embodiment, a function of chat that can transmit a message that is not reflected on Fixture Recap to the other party of a negotiation may be provided. FIG. 23 is a view showing an example of a negotiation screen on an owner side in which the chat function is provided. A screen shown in FIG. 23 is provided with an area 140 for entering a message to a charterer being the other party of a negotiation, a Send button 141 for transmitting a character string entered in the message entering area 140 to the other party of a negotiation and an area 142 for displaying a history of exchanges of messages in addition to an entering area for negotiation items that are reflected on Fixture Recap. In addition, although not shown, a negotiation screen on the charterer side is also provided with a function that is the same as the above-mentioned function. Further, although a display form of the entering area for the negotiation items in the figure is different from FIGS. 15 to 18 shown in the first embodiment, a processing flow for a negotiation is the same as that in the first embodiment.

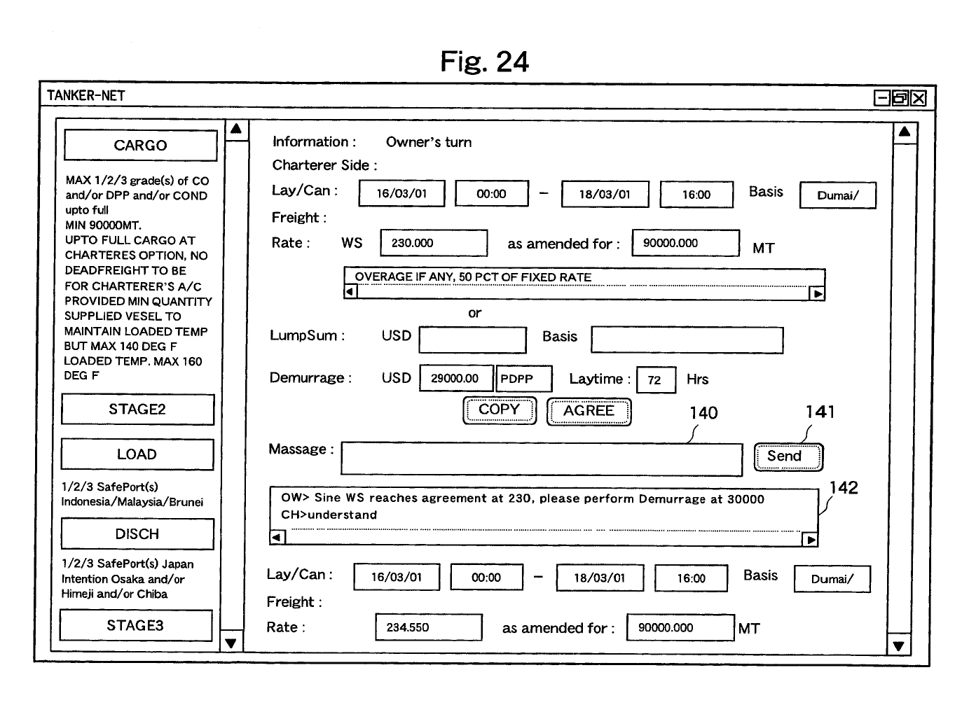

The owner and the charterer can enter a message in the message entering area 140 at any time during a negotiation and communicate the message to the other party of a negotiation. After entering a message, the message is displayed in the message display area 142 of the other party of a negotiation by clicking the Send button 141. FIG. 24 is an example showing a state in which a message is displayed in the message display area 142. A message entered by the owner side is indicated by “OW>” and a message entered by the charterer side is indicated by “CH>”. In this embodiment, a history of this message can be seen until the negotiation screen is closed but is not saved when the screen is closed.

As described above, a function of chat that is not reflected in contents of a charter is incorporated, whereby a charterer and an owner can promote mutual better understanding and proceed with a negotiation smoothly.

Third embodiment

In the above-described first embodiment, if the charterer and the owner has reached an agreement for all the negotiation items through the negotiation stage, contents of the agreement is arranged as a Fixture Recap. In this embodiment, a charter in a stage where a Fixture Recap is prepared is handled as a charter with subjects (On Sub Recap) to the end, and subjects are lifted (Sub Lift) and a charter from which the subjects are lifted (Clean Recap) is concluded in the next stage. Alternatively, if the subjects are not lifted, processing for regarding a charter as failed (Sub Failed) is performed.

Further, subjects as referred to in this context are different from the “subjects” presented by the owner and the charterer for each negotiation item in the negotiation stage of the first embodiment and “subjects” in terms of whether a situation for actually carrying out a charter is prepared. Roughly divided four subjects are included in this embodiment. These four subjects are STEM/SUPPLIERS/RECEIVERS/CHARTERER'S MANAGEMENT'S APPROVAL (a problem of a cargo, an approval of suppliers, an approval of receivers and a management's approval) and included in the On Sub Recap, but these subjects are not lifted at the point of conclusion of the On Sub Recap. The charterer confirms these subjects and, if the subjects are cleared, lifts the subjects of the vessel charter, or, if the subjects are not cleared, regards the vessel charter as failed (Sub Failed). The Clean Recap is concluded by the lifting of the subjects. Further, as an example in which a charter is failed, there are such a case in which it is found that a vessel of the On Sub is too large and cannot come alongside a pier of a loading area or in which an estimate of demand and supply of tanks in a loading area is wrong, whereby a Lay Can (shipping) is changed and a vessel cannot be arranged. In addition, not only the above-mentioned four subjects but also additional subjects (rider close) can be presented to the owner from the charterer anew and, if the owner cannot agreed to the presented subjects, a charter can be regarded as failed even if other subjects are cleared.

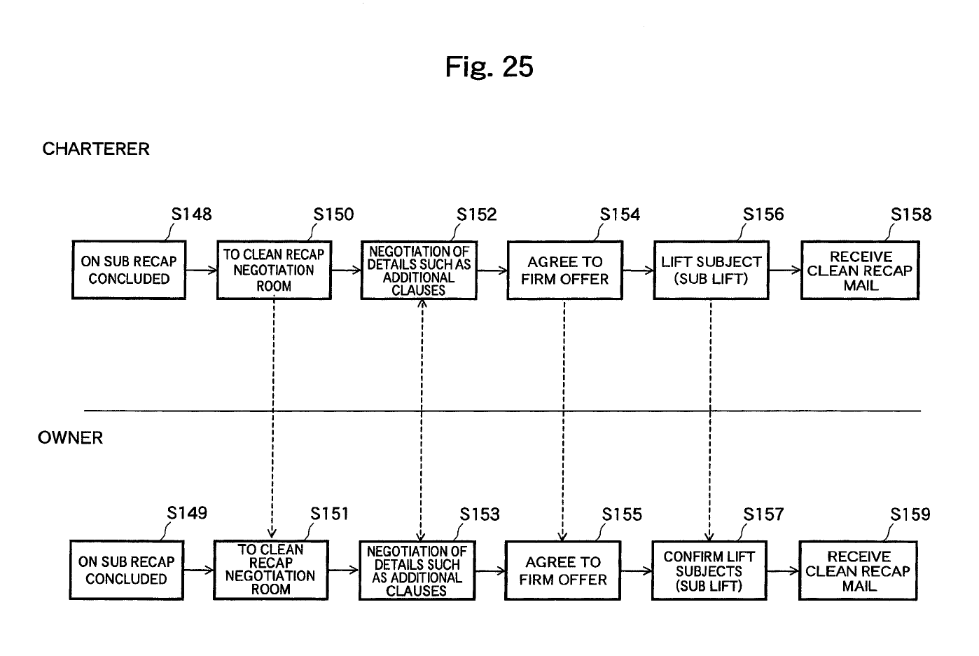

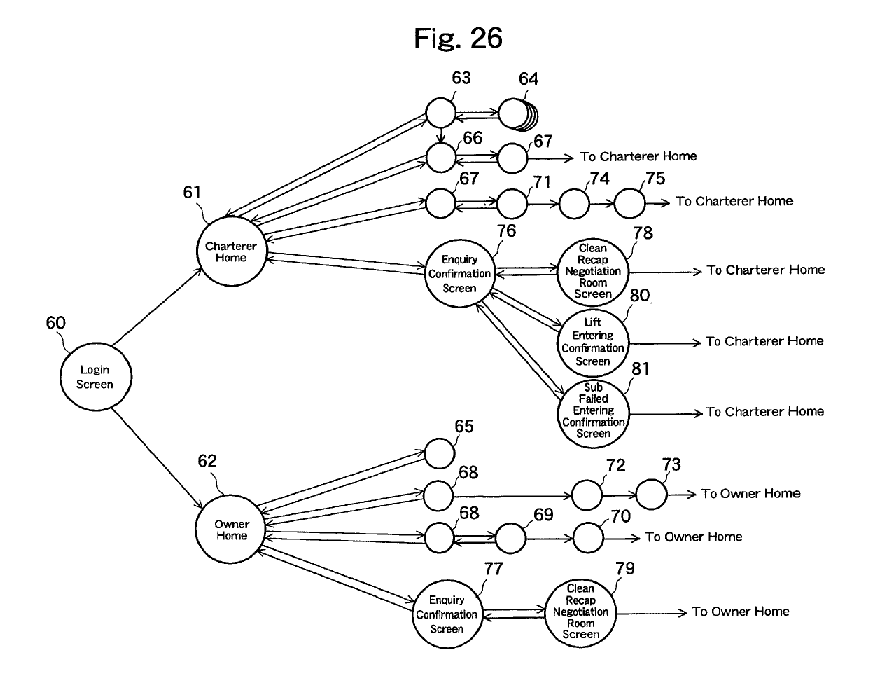

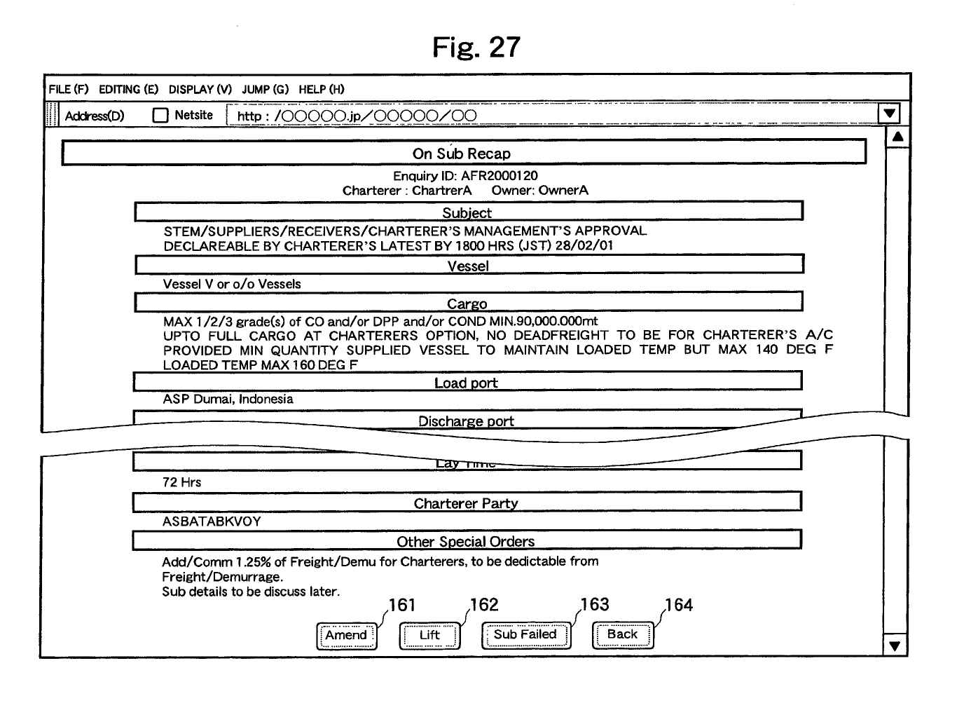

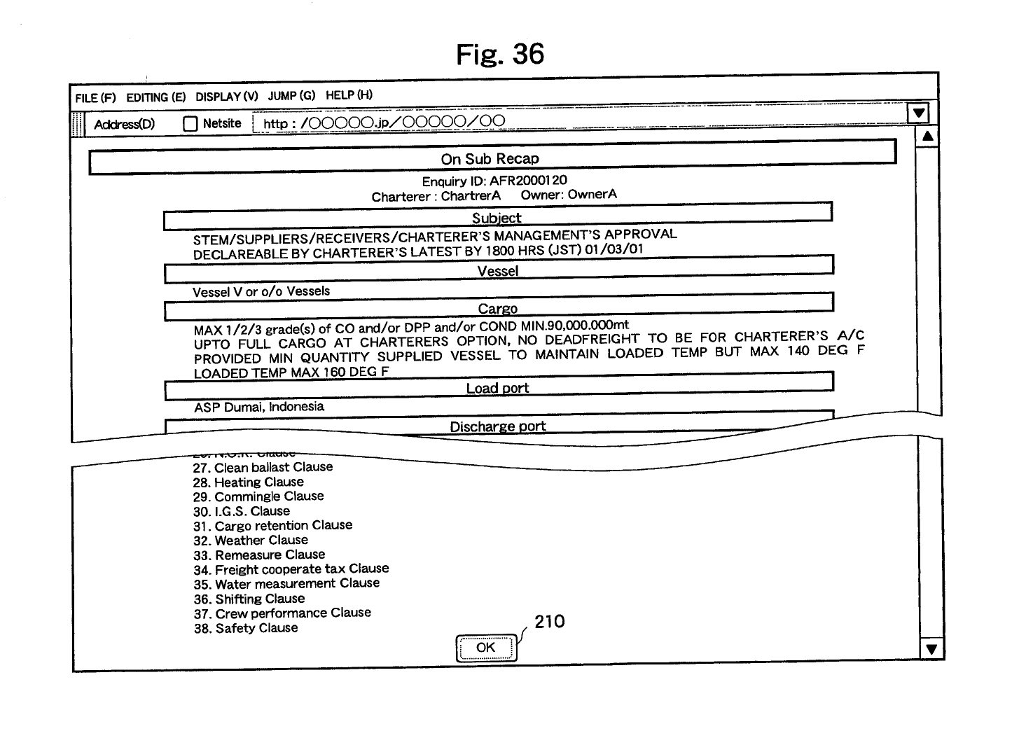

FIG. 25 is a flow chart showing a flow of processing from the On Sup Recap to conclusion of the Clean Recap among the procedures of a vessel charter utilizing the vessel charter supporting system in this embodiment. Moreover, FIG. 26 is a transition diagram of a display screen along the processing of the flow chart. In FIG. 26, name of screens are omitted for parts overlapping the screens shown in FIG. 4. In addition, FIGS. 27 to 37 show an example of each screen to be displayed during execution of the processing of the flow chart.

First, as in the first embodiment, when the owner and the charterer mutually agree on each negotiation item in the stage of a negotiation, a vessel charter is concluded (FIG. 25, S148 and S149). However, in this embodiment, the vessel charter that is concluded in this stage is “a vessel charter with subjects (On Sub Recap)” and it is necessary to conclude a vessel charter from which subjects are lifted in order for the owner and the charterer to implement this charter. When a vessel charter with subjects is concluded, statuses (111, 113) of a pertinent enquiry ID of enquiry confirmation screens 76 and 77 (the same as FIGS. 10 and 11, respectively) of the charterer and the owner of FIG. 26 turn into “On Sub” indicating that a vessel charter with subjects has been concluded.

When the charterer clicks an enquiry ID having this status, the charterer enters a negotiation stage (Clean Recap Negotiation Room) for concluding a Clean Recap for the pertinent vessel charter with subjects (FIG. 25, S150). FIG. 27 is an example of an initial screen of a Clean Recap Negotiation Room screen 78 on the charterer side in FIG. 26. Contents of an On Sub Recap charter is displayed in the upper part of this screen and an Amend button 161, a Lift button 162, a Sub Failed button 163, a Back button 164 are provided in the lower part. The charterer clicks the Amend button when starting a negotiation of amendment for displayed contents of a charter, additional subjects or the like, the Lift button 162 when lifting subjects of the charter, the Failed button 163 when regarding a charter as failed as subjects cannot be lifted, and the Back button 164 when returning to the enquiry confirmation screen 76.

First, the case of amendment for contents of a charter and addition of subjects will be hereinafter described in detail. When the charterer clicks the Amend button 161 in the screen of FIG. 27, the pertinent owner is called to a negotiation. In the enquiry confirmation screen 77 (FIG. 11) of the owner, the status 113 of an enquiry ID called to a negotiation changes from “On Sub” to “Call”. When the owner clicks an enquiry ID having this status, the owner can shift to a negotiation screen 79 of the Clean Recap in FIG. 26 (FIG. 25, S151).

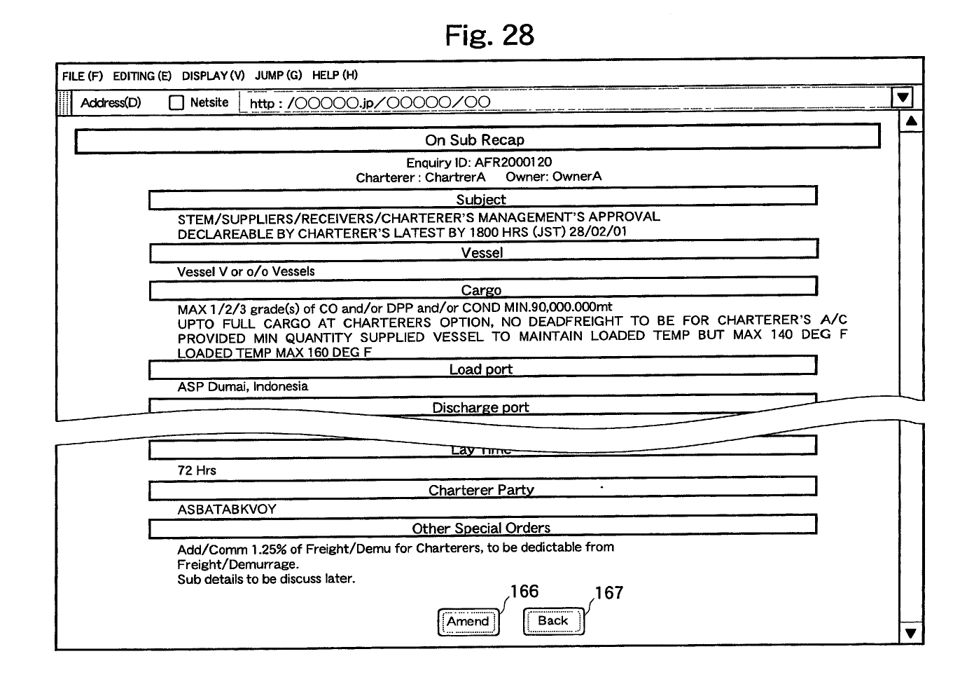

FIG. 28 is an example of the initial screen of the Clean Recap Negotiation Room screen 79 on the owner side in FIG. 26. Contents of a charter are displayed in the upper part of this screen as in FIG. 28, and an Amend button 166 and a Back button 167 are provided in the lower part. An owner clicks the Amend button 166 when the owner negotiate the displayed contents of a charter and clicks the Back button 167 when the owner returns to the enquiry confirmation screen 77. Further, since the owner cannot lift subjects of a charter or regard a charter as failed, a Lift button and a Sub Failed button are not provided as in a screen of a charterer. Here, when the owner clicks the Amend button 166, the owner and a charterer can start a negotiation.

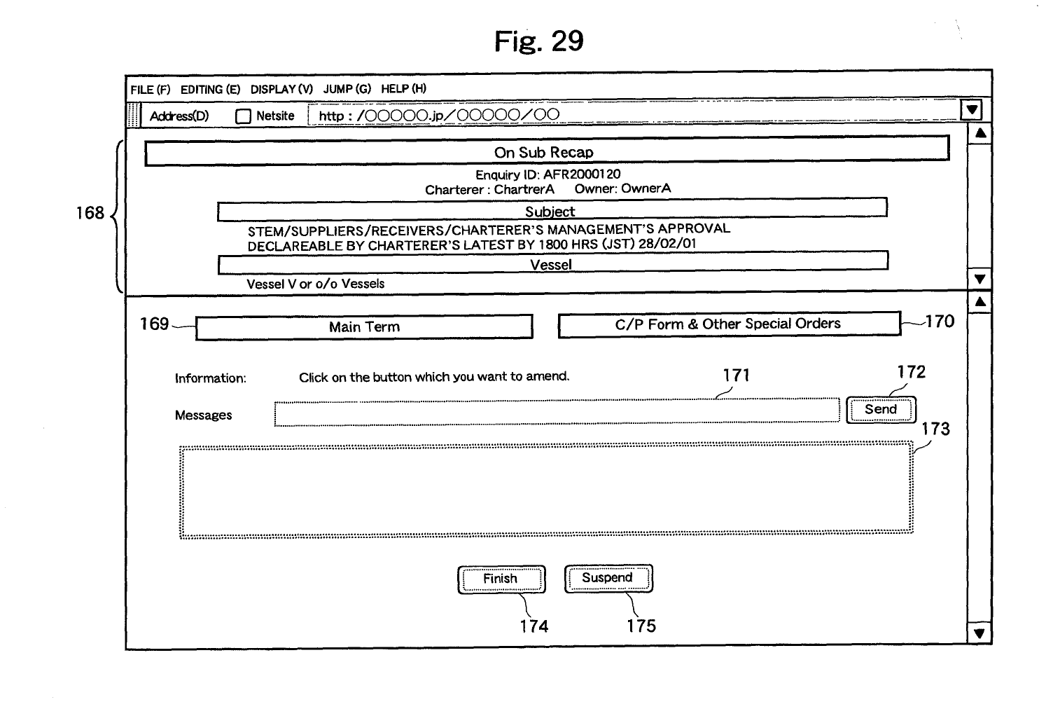

As the negotiation is started, an On sub Recap 168 is displayed on the upper part of the screen of the charterer and an area for a negotiation is displayed in the lower part as shown in FIG. 29. In the area for a negotiation, a button (Main Term button) 169 for causing the system to display a negotiation screen for performing fine tuning for predetermined items that has already concluded in the On Sub Recap and a button (C/P Form & Other Special Orders) 170 for causing the system to display a screen for performing a negotiation for a charter party and other items other than the items shown in the Main Term among the items already concluded in the On Sub Recap are provided.

In addition, a chat function with which an owner and a charterer exchange messages that are not reflected in negotiation items separately from such a negotiation is provided on this screen. An area for the chat function is always displayed on both screens of the owner and the charterer, on which the owner and the charterer can exchange messages that are not reflected in a negotiation until the negotiation ends. Describing the exchange of messages on the screen of the charterer of FIG. 29, a charterer enters a message in a message entering area 170 and clicks a Send button 171, and then the entered message is displayed in a message display area 172 and, at the same time, the same message is displayed in a message display area of the other party of a negotiation as in the second embodiment. A history of messages continues to be displayed in the message display area 172 until a negotiation ends. Further, this is the same on a screen of an owner.

On this screen, the charterer can finish the negotiation by clicking a Finish button 174 and can temporarily suspend the negotiation by clicking a Suspend button 175. Further, when the charterer clicks the Suspend button 175, the statuses (111, 113) of the pertinent enquiry ID to be displayed on FIGS. 10 and 11 change to “Proceed”.

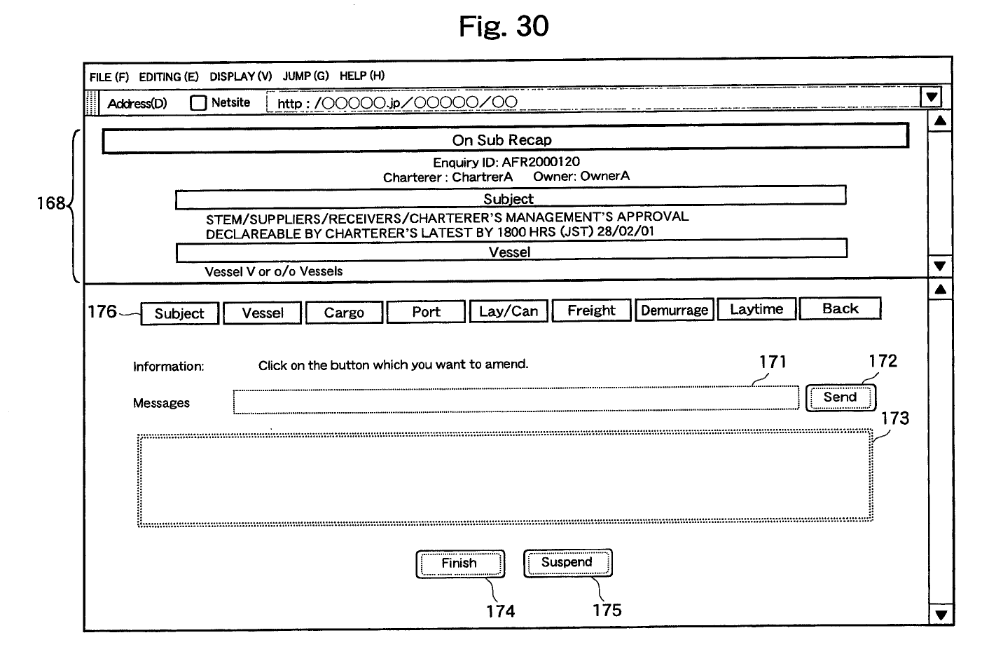

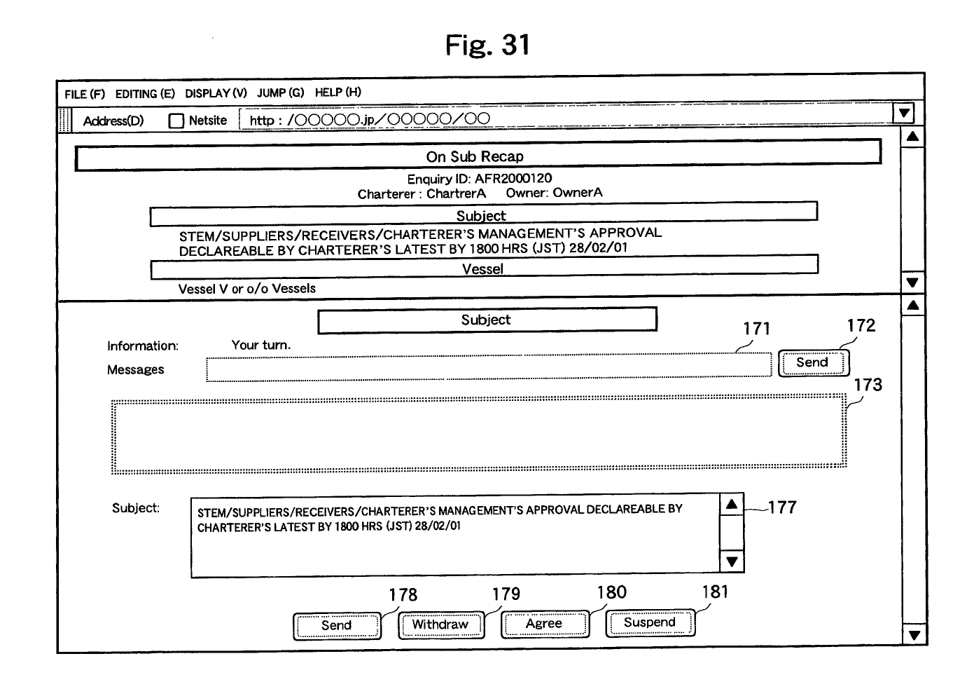

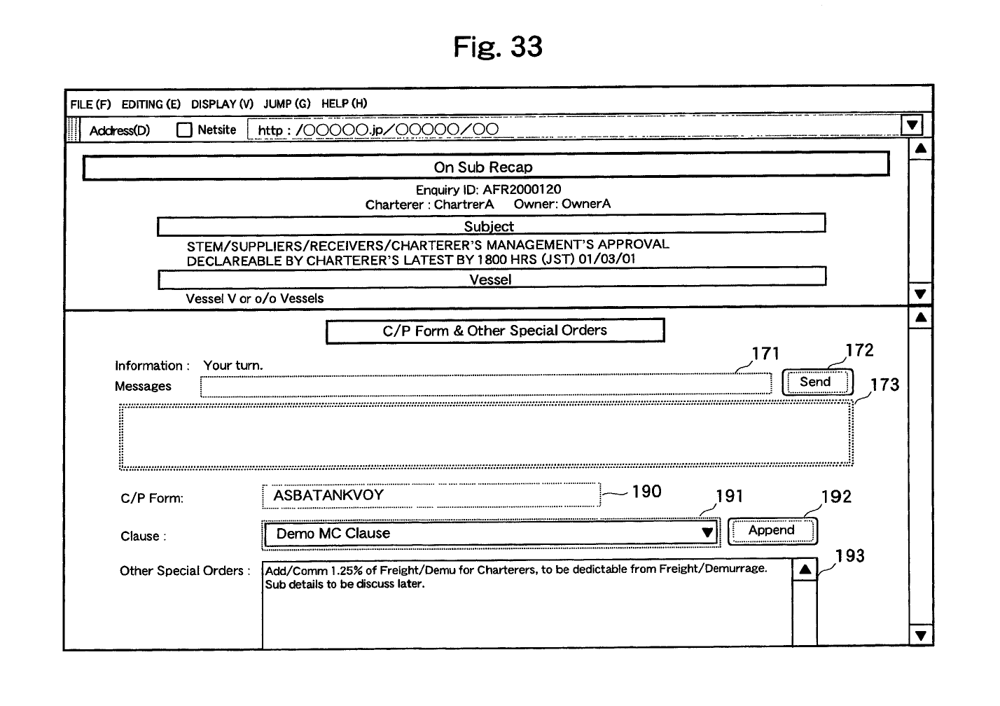

First, processing for performing fine tuning in the Main Term will be described. When the charterer clicks the Main Term button 169 in FIG. 29, a screen of FIG. 30 is displayed on the charterer side. Then, buttons 176 for respective items are displayed and the charterer can perform amendment of a pertinent item by clicking any of the buttons. Here, if the charterer wishes to amend Subject, the charterer clicks a Subject button. Then, the screen is switched to that of FIG. 31. Contents for the Subject of the On Sub Recap are displayed in an editing area 177. Further, a screen similar to that in FIG. 33 is displayed on the owner side. When the charterer directly enters contents of change in this editing area 177 and clicks a Send button 178, amended contents of the charterer are displayed in an editing area 184 of the screen on the owner side and an On sub Recap 182 in the upper part of the screen (FIG. 25, S152). Further, it is more preferable if a color of characters in the amended part displayed on the On Sub Recap 182 is different from a color of characters in the part other than the amended part. For example, the change can be made clear by displaying the contents with different colors of characters such as black as an ordinary color of characters, blue for an amended part, red for an added part and olive for a deleted part.

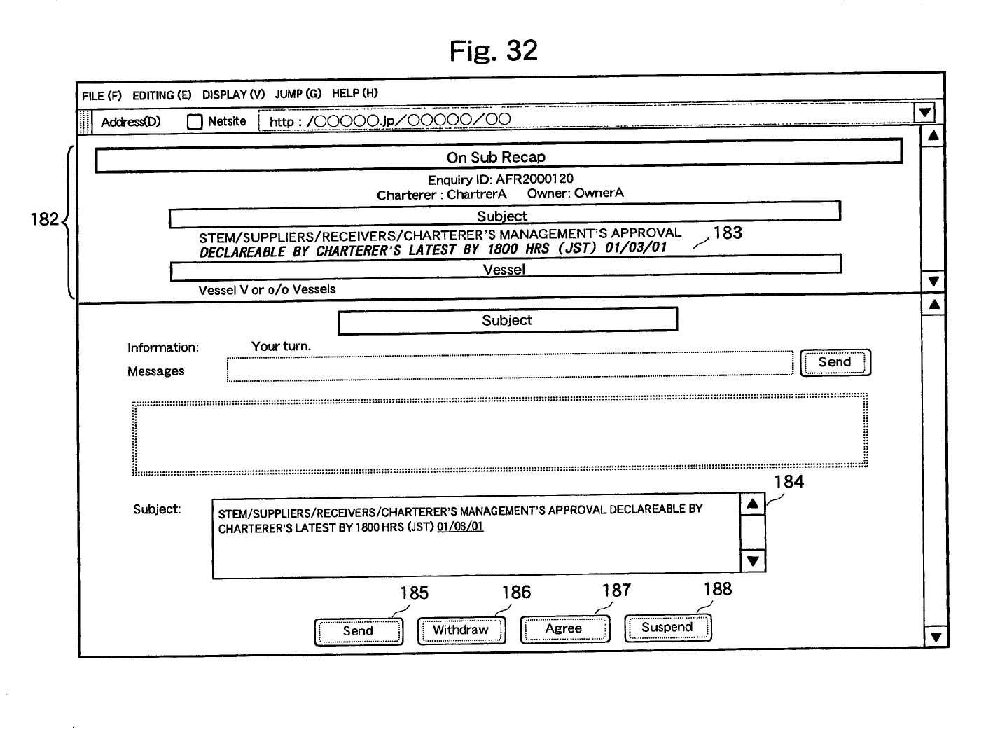

If the owner wishes to further amend the amendment, the owner changes a character string displayed on the editing area 184 and clicks a Send button 185. Then, contents amended by the owner are displayed without change on the editing area 177 on the screen on the charterer side in FIG. 31 (FIG. 25, S153). At the time of agreeing to amended contents of the other party of a negotiation, the charterer clicks an Agree button 180 on the screen (FIG. 31) and the owner clicks an Agree button 187 on the screen (FIG. 32) (FIG. 25, S154 and S155). In addition, at the time of canceling the amended contents entered in the editing areas 177 and 184 without transmitting them to the other party of a negotiation, the charterer clicks a Withdraw button 179 on the screen (FIG. 31) and the owner clicks a Withdraw button 186 on the screen (FIG. 32). At the time of suspending the negotiation, the charterer clicks a Suspend button 181 on the screen (FIG. 31) and the owner clicks a suspend button 188 on the screen (FIG. 32).

Next, processing of a negotiation for a charter party and other items will be described. When the charterer clicks the C/P Form & Other Special Orders 170 on the screen (FIG. 29) of the charterer, a screen shown in FIG. 33 is displayed on the charterer side and a negotiation is started. The On Sub Recap is displayed in the upper part of the screen as in the above-mentioned Main Term amendment screen (FIG. 31) and an area for a negotiation is displayed in the lower part of the screen. Areas (171, 172 and 173) for exchanging messages are provided in this area for a negotiation as in the above-mentioned FIG. 31, with which the charterer can exchange messages at any time until the negotiation ends, and a history of messages continues to be displayed until the negotiation ends. This is the same in the screen on the owner side.

A name of a charter party agreed upon in the On Sub Recap is displayed in a charter party display area (C/P Form) 190 in FIG. 33. Here, when the charterer wishes to add a clause (charter clause), the charterer enters the clause to be added in a clause entering area (Clause) 191 and clicks an Append button 192. In this embodiment, a clause is entered by selecting it from pull-down menus. The charterer can prepare and name clauses to register them in the system in advance. Preparation of a clause will be described in a fourth embodiment.

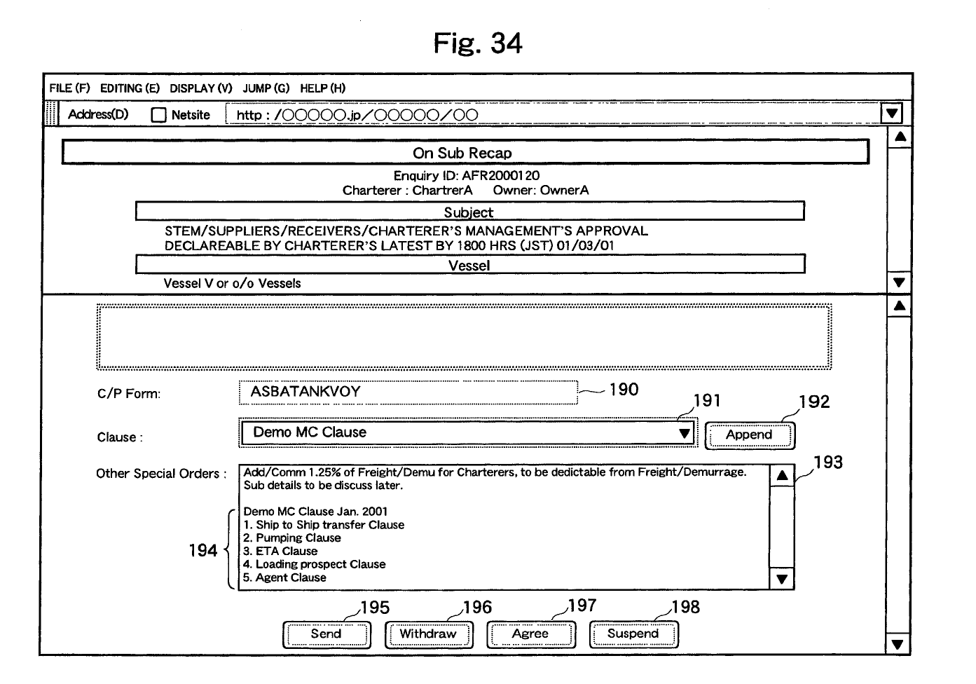

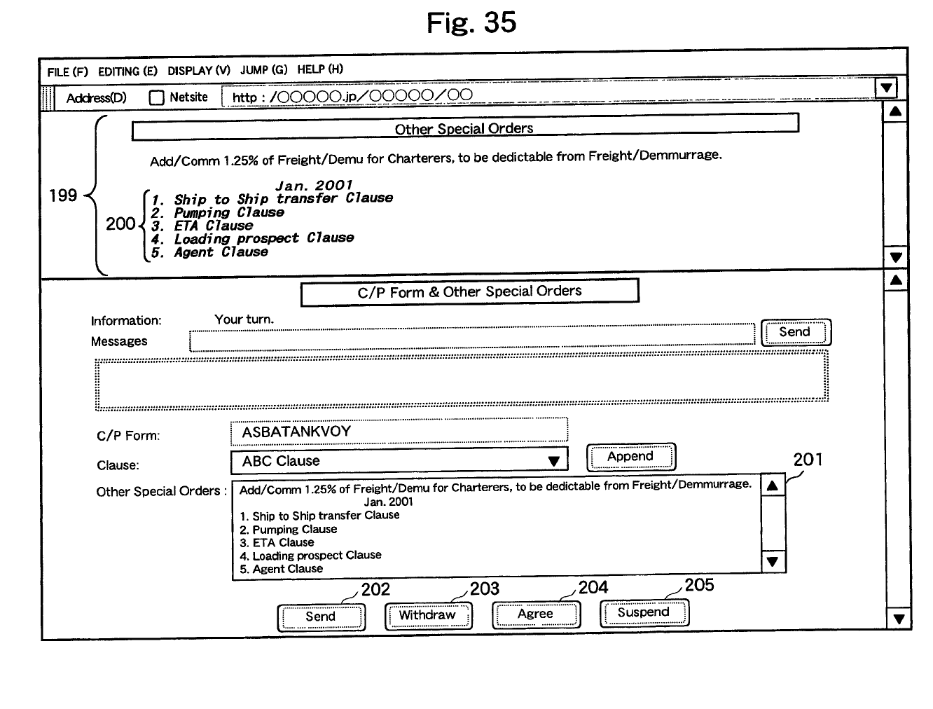

When the charterer clicks the Append button 192, contents of the selected clauses are added in the Other special Orders editing area 188. A situation in which clauses are added is shown in the editing area 193 of FIG. 34. A part denoted as 194 is an added part. When the charterer clicks a Send button 195 in this state, the contents shown in the editing area 193 are displayed on the screen on the owner side without change (FIG. 25, S152). Contents changed by the charterer are displayed in an editing area 201 and an On Sub Recap 199 on the screen on the owner side shown in FIG. 35. In the On Sub Recap 199, it is more preferable if a part changed by the charterer 200 is displayed with a color different from that of the part other than the changed part as in the above-mentioned case. In addition, the owner can change the added clauses displayed on the editing area 201 that are received from the charterer and return them to the charterer. In this case, the owner clicks a Send button 202 after changing them. When the owner clicks the Send button 202, the change is also reflected on the screen on the charterer side (FIG. 25, S153).

At the time of agreeing to contents changed by the other party of a negotiation in such a manner, the charterer clicks an Agree button 192 on the screen (FIG. 34) and the owner clicks an Agree button 204 on the screen (FIG. 35) (FIG. 25, S154 and S155). At the time of canceling the changed contents entered in the editing areas 193 and 201 without transmitting them to the other party of a negotiation, the charterer clicks a Withdraw button 196 on the screen (FIG. 34) and the owner clicks a Withdraw button 203 on the screen (FIG. 35). At the time of suspending the negotiation, the charterer clicks a Suspend button 198 on the screen (FIG. 34) and the owner clicks a Suspend button 205 on the screen (FIG. 35).

When the agreement is reached with respect to each item and added clauses as described above, an amended On sub Recap is displayed on the screens of both the owner and the charterer. When the both of the parties clicks an OK button 210 in the lower part of the screen, the parties return to the enquiry confirmation screens 76 and 77 (FIGS. 10 and 11). “Proceed” is displayed in the status 111 of FIG. 10 and the status 113 of FIG. 11 at this point. When the charterer clicks an enquiry ID having such a status, the On Sub Recap is displayed as shown in FIG. 27, though its contents are changed. If all the subjects are lifted at this point, the charterer clicks the Lift button 162 in the screen (equivalent to a Lift entering confirmation screen 80 of FIG. 26) of FIG. 27 to enter to the effect that the subjects are lifted (FIG. 25, S156). Thus, a vessel charter “Clean Recap” from which subjects are lifted is prepared. In addition, the statuses (111, 113) of the pertinent enquiry ID turn into “Sub Lifted” in the enquiry confirmation screen 76 and 77 (FIGS. 10 and 11) of the charterer and the owner.

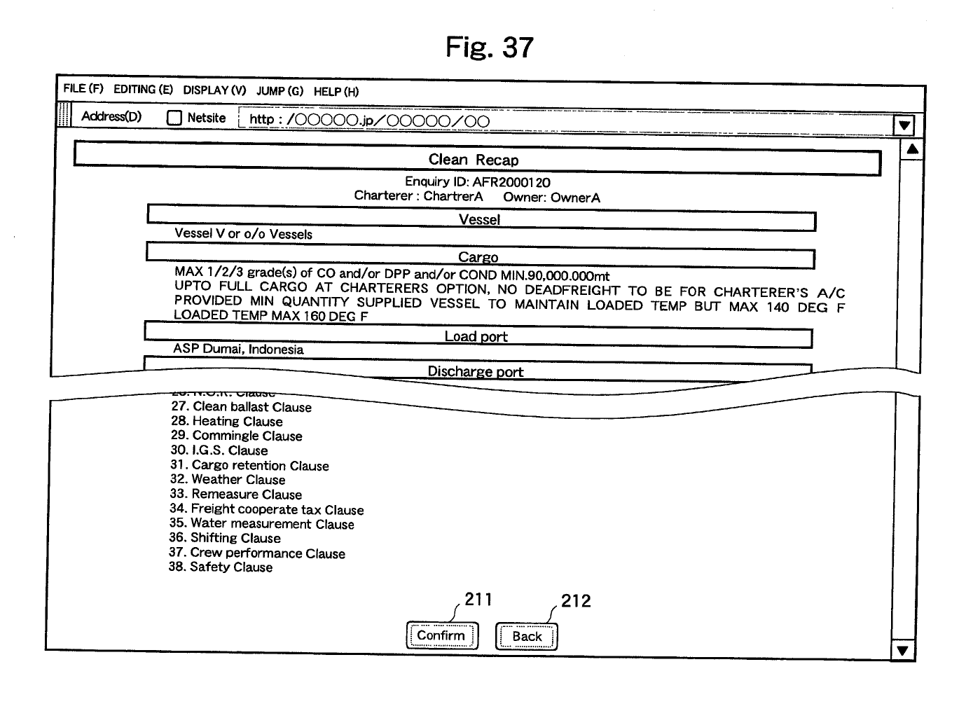

When the owner clicks an enquiry ID having the status in the enquiry confirmation screen 77 (FIG. 11), contents of the Clean Recap are displayed as shown in FIG. 37. The owner confirms this Clean Recap and clicks a Confirm button 211 (FIG. 25, S157). Further, at the time of returning to the enquiry confirmation screen 77, the owner clicks a Back button 212.

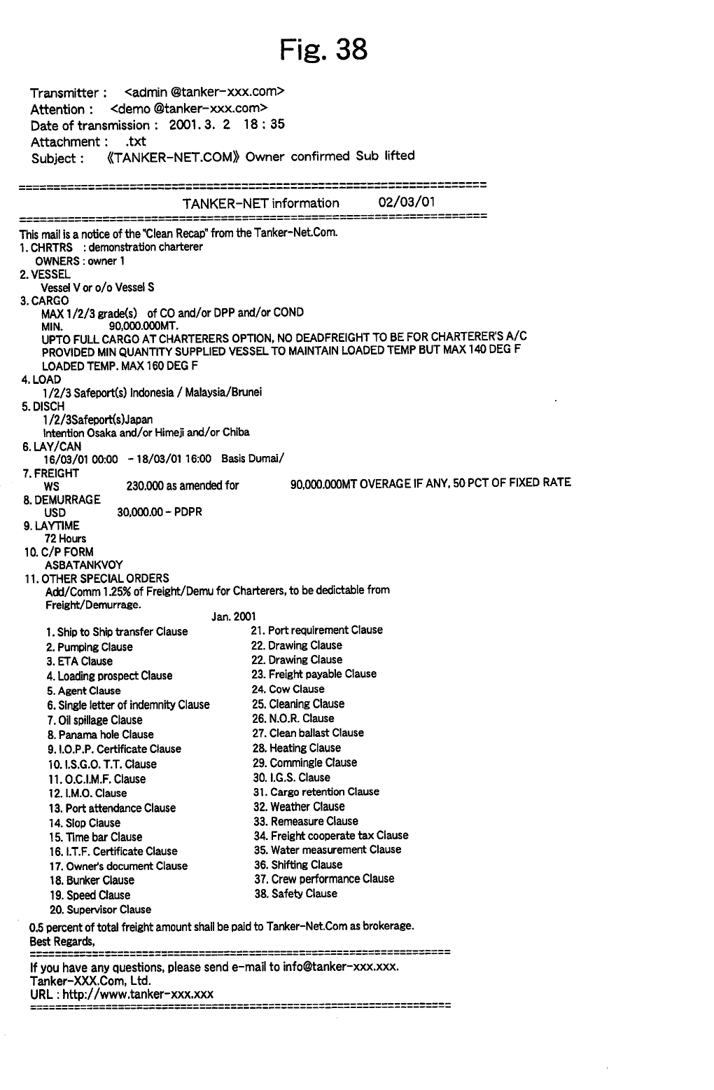

When the owner clicks the Confirm button 211, this system transmits the Clean Recap to the charterer terminal 27 and the owner terminal 28 by electronic mails (FIG. 25, S158 and S159). FIG. 38 is an example of transmission of an electronic mail. In addition, the statuses (111, 113) of the pertinent enquiry ID on the enquiry confirmation screens 76 and 78 (FIGS. 10 and 11) of the charterer and the owner turn into “Fixed”, and the vessel charter is inserted in a “Fixtures Report” of FIG. 22 shown in the first embodiment.

Further, if the subjects of the On Sub Recap are not lifted or the above-mentioned negotiation of amendment (addition of clauses or the like) of the On Sub Recap has not been concluded and has not reached an agreement, the charterer performs processing for regarding the charter as failed (Sub Failed). Here, the charterer clicks the Sub Failed button 163 in the screen (equivalent to a Sub Failed entering confirmation screen 81 of FIG. 26) of the above-described FIG. 27. Then, the statuses (111, 113) of the pertinent enquiry ID on the enquiry confirmation screens 76 and 77 (FIGS. 10 and 11) of the charterer and the owner turn into “Sub Failed”.

Fourth embodiment

In the third embodiment, it is described that a charterer prepares clauses and registered them in a system in advance. Processing for this preparation of clauses will be hereinafter described in detail. First, the charterer clicks “Clause List” out of the menu items 104 to be shown on the home screen of FIG. 6 and causes the system to display a screen for preparing a clause list. Further, since this menu items 104 are always displayed except a negotiation screen for preparing an On Sub Recap and a negotiation screen for preparing a Clean Recap, the charterer can shift to a clause list preparation screen at any point of time other than a negotiation, thus a screen for shifting to a clause list preparation screen is not specifically limited to the home screen of FIG. 6.

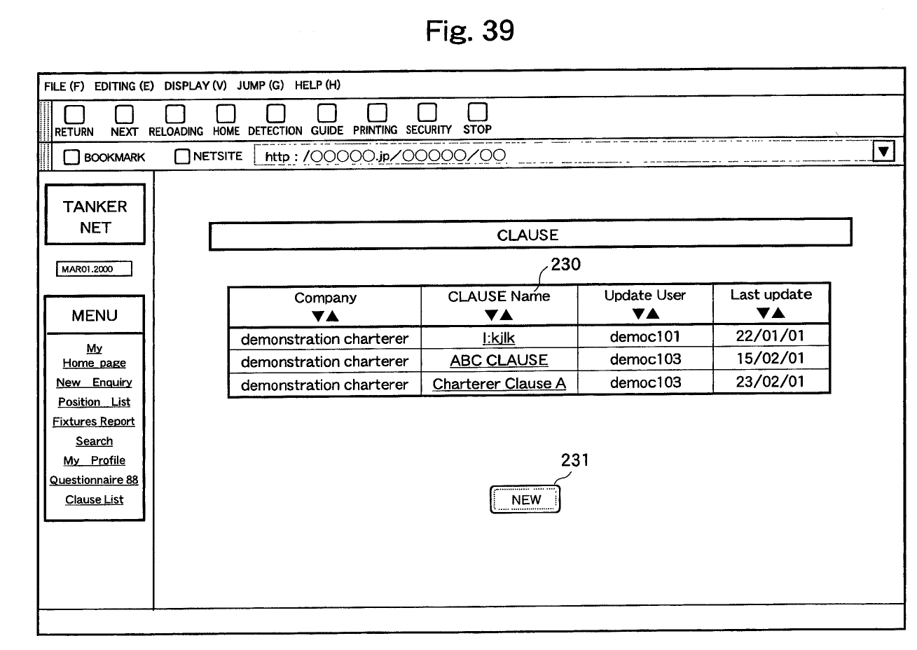

When the charterer clicks the “Clause List”, the charterer shifts to a top page of a clause preparation screen as shown in FIG. 39. As shown in the drawing, clauses prepared by the charterer up to the point are displayed as a list. Clause names 230 are displayed in the list, and upon clicking any of the names, the charterer can inspect its contents. When the charterer clicks a NEW button 231 in the figure, the charterer shifts to a new preparation screen.

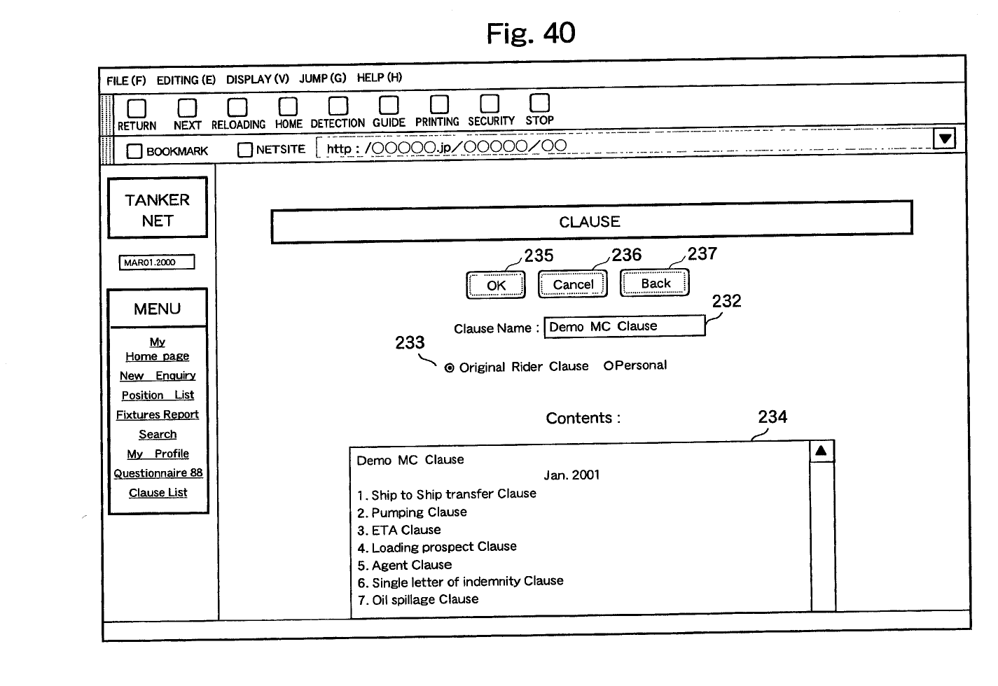

A screen after the charterer clicks the NEW button 231 is shown in FIG. 40. The charterer enters a name of a clause to be prepared anew on Clause Name 232. In addition, the charterer selects whether the clause to be prepared is for an original additional clause “Original Rider Clause” or one for personal use by a radio button 233. An area 234 for entering contents is provided in the lower part of the screen, in which the charterer can enter contents of a clause freely. After entering these items, the charterer clicks an OK button 235. Further, at the time of wishing to cancel an entering, the charterer clicks a Cancel button 236 and, at the time of wishing to return to the previous screen, the charterer clicks a Back button 237.

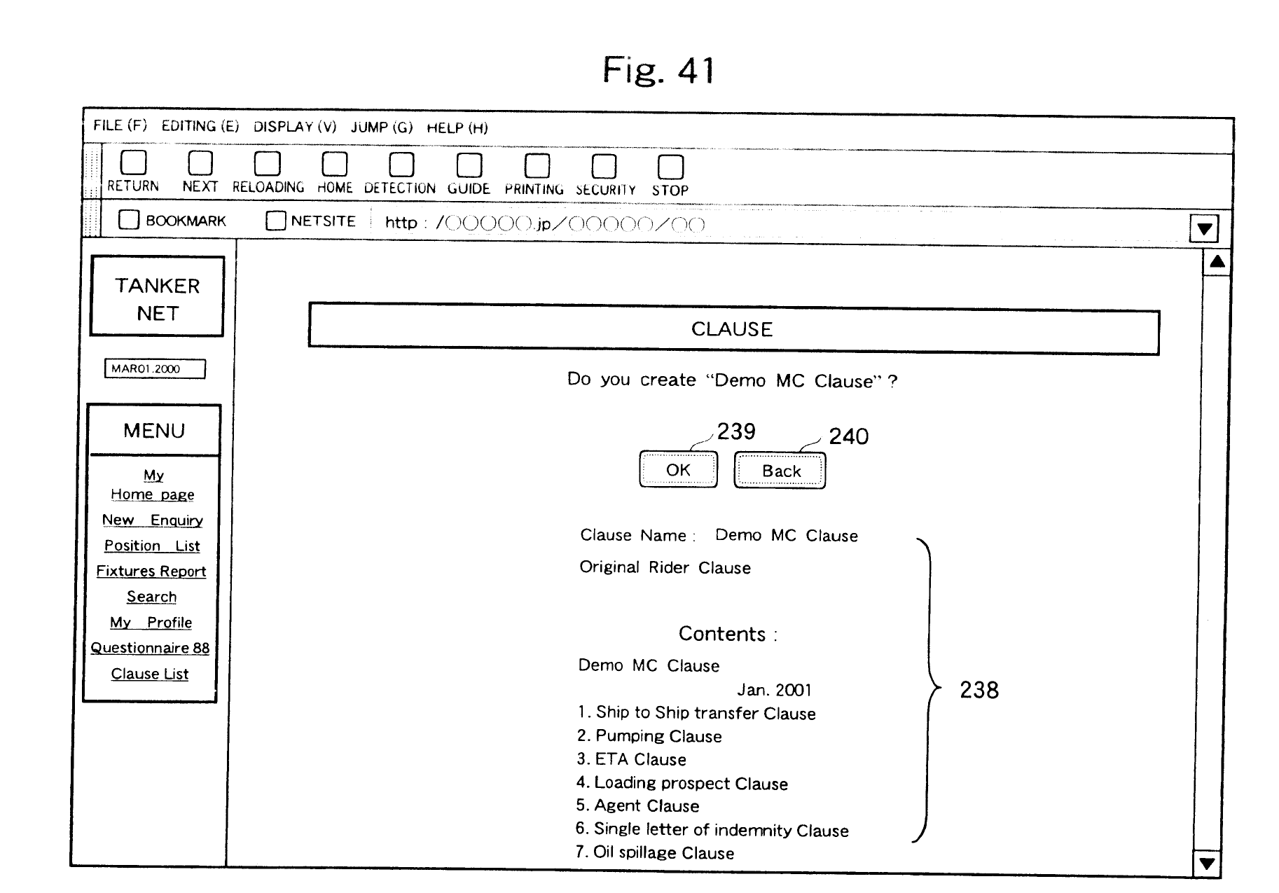

If the OK button 235 is clicked, a screen of FIG. 41 is displayed. After confirming contents 238 of a clause prepared on this screen, the charterer clicks an OK button 239 if there is no problem or clicks a Back button if amendment is required. If the charterer clicks the Back button 240, the charterer can return to the clause preparation screen (FIG. 40) and change the contents.

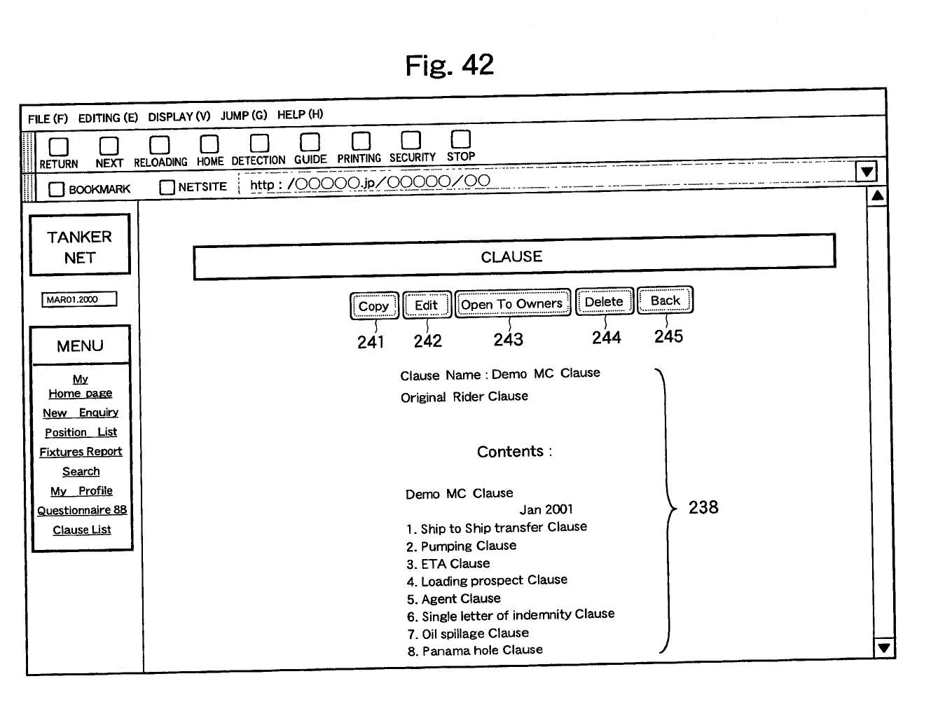

If the OK button 239 is clicked, a screen of FIG. 42 is displayed. The contents 238 of the prepared clause are displayed as in FIG. 41 and, upon clicking a Copy button 241 in the upper part of the screen, the charterer can prepare a new clause utilizing the displayed clause. In addition, upon clicking an Edit button 242, the charterer can amend the displayed clause. Upon clicking a Delete button 244, the charterer can delete the displayed clause. With a Back button 245, the charterer can return to the previous screen. Moreover, by clicking an Open To Owners button 243, the charterer can select to which owner the charterer lays open a prepared clause on this screen. Further, the screen shown in FIG. 41 is also displayed when the user clicks any of the clause names 230 in the list of FIG. 39, and the charterer can perform processing similar to the above.

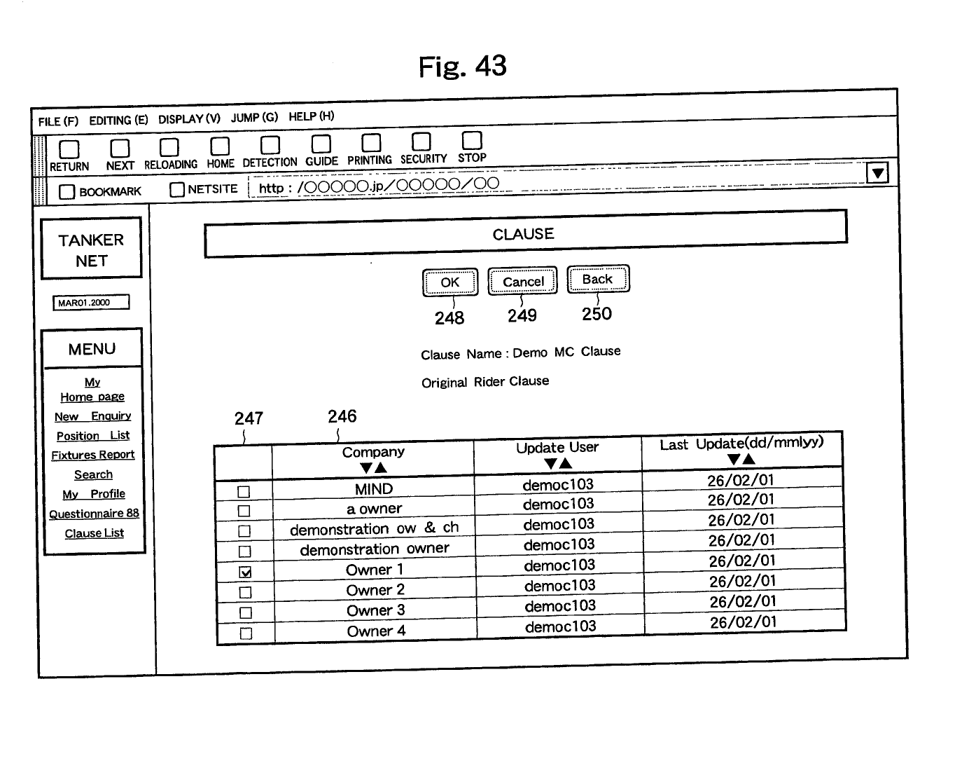

If the Open To Owners button 243 is clicked, a screen of FIG. 43 is displayed. A list of owners is displayed on the screen and, the charterer checks a check box 247 positioned to the left of a name 246 of an owner to which the charterer wishes to lay open the prepared clause, thereby being able to select an owner to which the charterer wishes to lay open the clause. Upon checking an owner, the charterer clicks an OK button 248. The clause is not laid open to owners that are not checked. Further, at the time of wishing to cancel the check, the charterer clicks a Cancel button 249 and, at the time of wishing to return to the previous screen, the charterer clicks the Back button 250.

If the OK button 248 is clicked, the charterer returns to the clause preparation initial screen of FIG. 39, and the prepared clause is added to the list (not shown). Here, if the charterer wishes to prepare a clause anew, the charterer can continue the clause preparation processing by clicking the NEW button 231.

Fifth embodiment

An owner can freely update the position list in a first embodiment. Update processing of the position list will be hereinafter described in detail. First, the owner clicks “Position List” out of the menu items 114 in FIG. 11. Further, since the menu items 114 are always displayed on any screen except in a negotiation stage, it is not limited to FIG. 11.

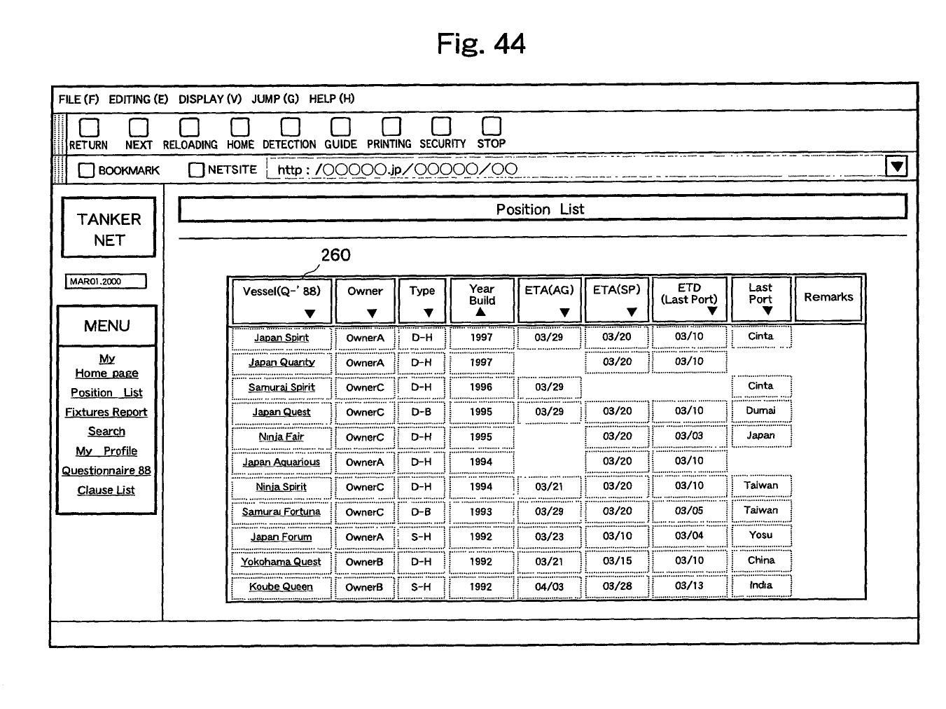

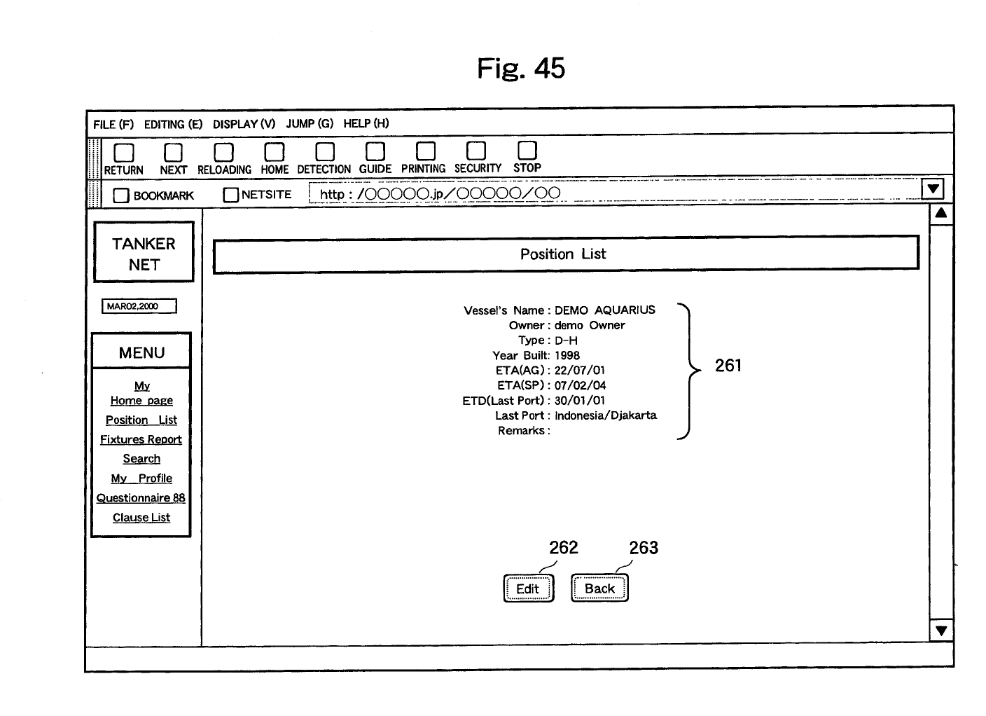

If the Position List is clicked, a position list screen of FIG. 44 is displayed. In FIG. 44, the owner clicks a name of a vessel that the owner wishes to update among displayed names of vessels 260 in FIG. 44. Here, although vessels of other companies are displayed on the list, the vessels of other companies can only be inspected and the owner can update its own vessels only. When the owner clicks any of the names of vessels 260 a screen of FIG. 45 is displayed. On this screen, positional information of the vessel is displayed in an area 261, and the owner clicks an Edit button 62 at the time of performing update or clicks a Back button 263 when returning to the previous screen.

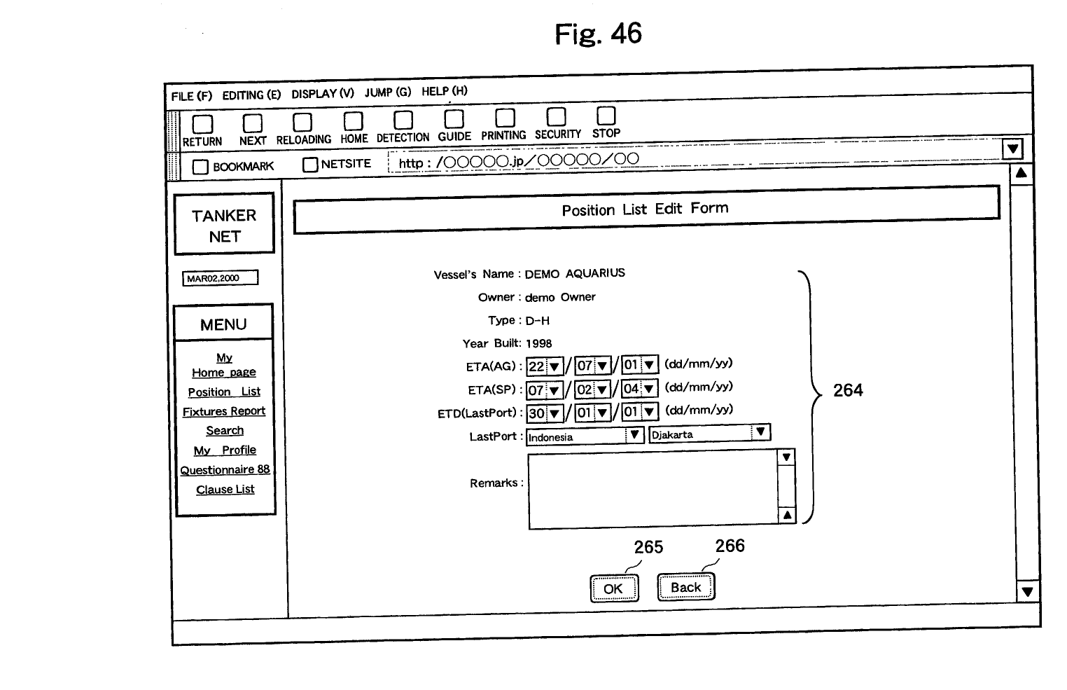

When the Edit button 262 is clicked, an update screen of FIG. 46 is displayed. The owner enters contents of the update in an update entering area 264 and clicks an OK button 265 after the entering. In addition, at the time of returning to the previous screen (FIG. 45) without changing anything, the owner clicks a Back button 266. When the OK button 265 is clicked, the owner returns to the screen of FIG. 44, and a list is displayed with the contents of the update entered in FIG. 46 reflected on it (not shown).

Sixth embodiment

An owner can change the Questionnaire' 88 in the first embodiment freely. Change processing of the Questionnaire' 88 will be hereinafter described in detail. First, the owner clicks “Questionnaire' 88” out of the menu items 114 in FIG. 11. Further, since the menu items 114 are always displayed on any screen except in a negotiation stage, it is not limited to FIG. 11.

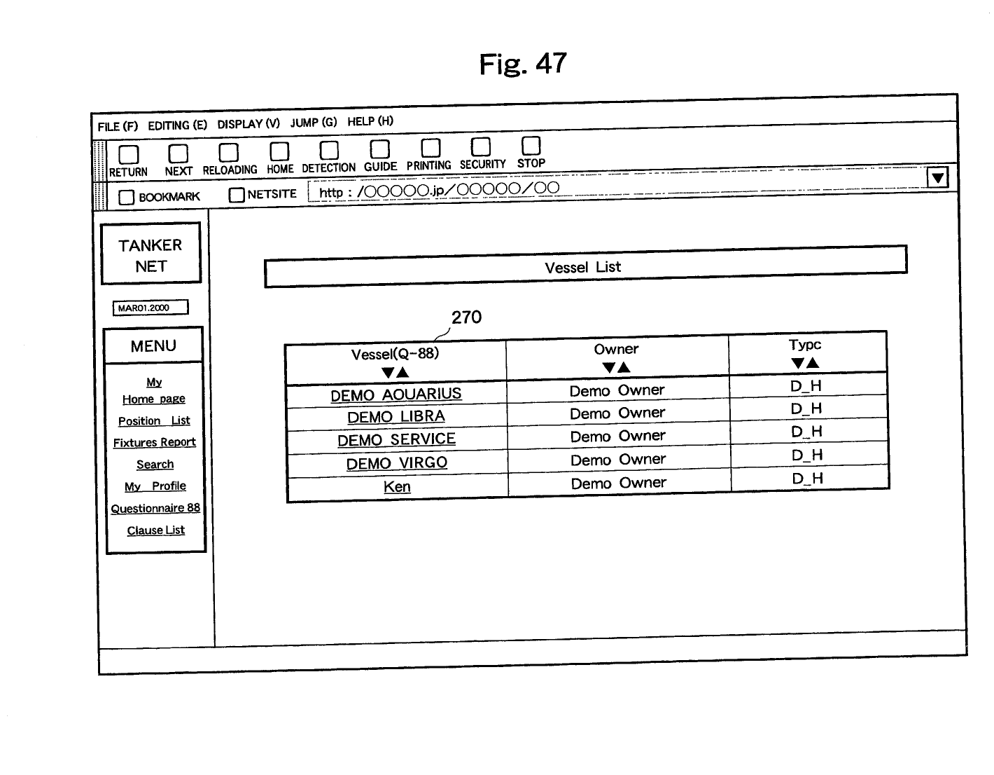

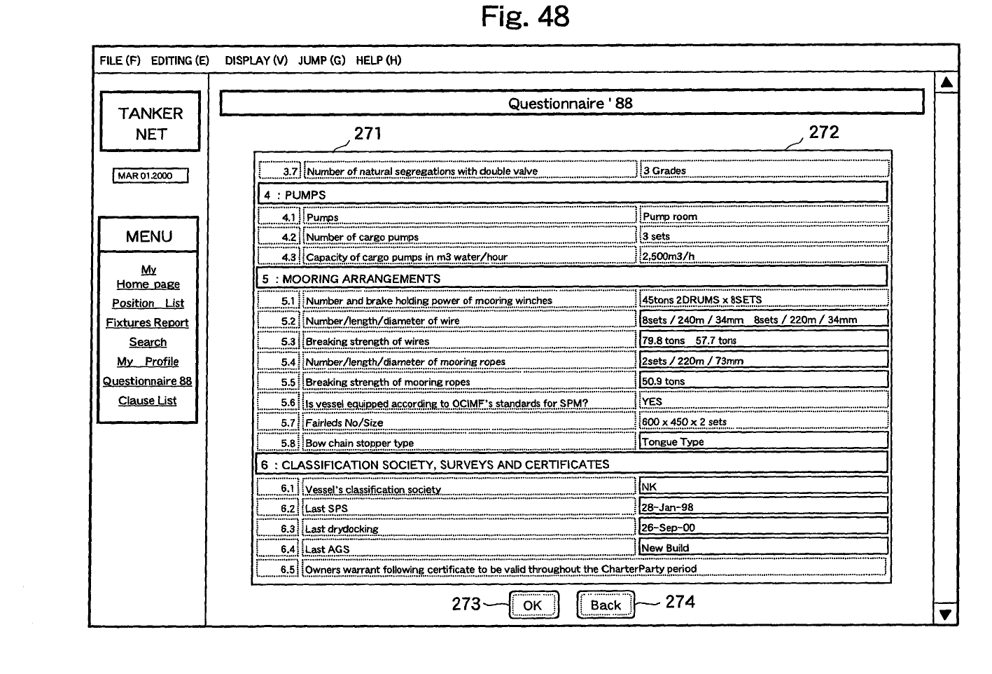

If the Questionnaire' 88 is clicked, a list screen of FIG. 47 is displayed. In FIG. 47, the owner clicks a name of a vessel that the owner wishes to change among displayed names of vessels 270 in FIG. 47. When the owner clicks any of the names of vessels 270, a screen of FIG. 48 is displayed. As shown in the drawing, although data 272 of vessels corresponding to items are displayed on the left side of names of the items 271, only items that can be changed are made available for change entering in this embodiment. Here, the owner enters contents of the change and clicks an OK button 273 after completing the entering. In addition, the owner clicks a Back button 274 at the time of returning to the previous screen (FIG. 47) without changing anything. When the OK button 273 is clicked, the owner returns to the screen of FIG. 47 and a list is displayed with the contents of the change entered in FIG. 48 reflected on it (not shown).

The first to the sixth embodiments described above are merely examples of the present invention and have no specific limitation for a screen configuration, a flow of processing or the like, thus can be properly applied within a range of the spirit of the present invention. In addition, although the embodiments have been described with reference to the case in which the present invention is applied to a tanker as a vessel as an example, it is needless to mention that the present invention can be similarly applied to a tramp vessel such as a bulk loading vessel, an automobile transporting vessel, a refrigeration vessel, an LPG vessel, an LNG vessel, a chemical tanker and a mixed use vessel.

Industrial Applicability

As described above, the present invention makes it possible to conclude a vessel charter to be entered into between an owner of a vessel and a charterer by negotiating on a real time basis over a network without the intervention of a broker. Thus, a direct negotiation between a charterer and an owner becomes possible and there is an effect of shortening information transmission time and reducing expenses for chartering a vessel on an owner side compared with a conventional negotiation by telephones or the like via a broker. At the same time, it is possible to directly grasp a situation of a negotiation. In addition, since it becomes possible to conclude a vessel charter without worrying about a difference of time, convenience is improved.

Moreover, since items of a negotiation are entered and agreement is made on them over a network directly, there are effects that it is possible to grasp the items of a negotiation accurately and quickly and at the same time labor for preparing a charter requiring descriptions of every content of a negotiation is reduced and a charter is concluded quickly compared with conventional communication by telephones or facsimiles.

1. A vessel charter supporting system for supporting a vessel charter to be entered into between an owner and a charterer, characterized by comprising;
an information terminal for a charterer owned by said charterer;
an information terminal for an owner owned by said owner;
a storage unit for storing predetermined information required for said vessel charter, information entered by said charterer and information entered by said owner; and
a control unit for forming a screen for entering predetermined information or a screen for displaying information based on information entered from said information terminal for a charterer, information entered from said information terminal for an owner and information stored in said storage unit to support conclusion of the vessel charter while causing said information terminal for a charterer and said information terminal for an owner to appropriately display the screens, respectively.

2. The vessel charter supporting system according to claim 1,
characterized in that said screen for entering predetermined information includes an enquiry information entry screen displayed on said information terminal for a charterer for entering enquiry information concerning a vessel that meets conditions with which said charterer intends to charter the vessel or a predetermined vessel that said charterer intends to charter and causing the owner to present an indication for the enquiry.

3. The vessel charter supporting system according to claim 2,
characterized in that said enquiry information entry screen includes at least one of a screen for making an enquiry not specifying an owner or a screen for making an enquiry specifying at least one owner.

4. The vessel charter supporting system according to claim 2 or claim 3,
characterized in that said screen for entering predetermined information includes a screen for entering indication information for said owner to enter an indication to said enquiry information from said information terminal for an owner and presenting the indication information to said charterer.

5. The vessel charter supporting system according to claim 4,
characterized in that said screen for displaying information includes a screen for displaying indication information for causing said information terminal for a charterer to display an indication from said owner to enquiry information from said charterer.

6. The vessel charter supporting system according to claim 5,
characterized in that, if indications are received from a plurality of owners, the indications are also shown on said screen for displaying indication information.

7. The vessel charter supporting system according to claim 5 or claim 5,
characterized in that said screen for displaying indication information is provided with an expression of intention information entering section for designating an owner with whom the charterer negotiates and expressing an intention for shifting to a negotiation.

8. The vessel charter supporting system according to claim 7,
characterized in that, if expression of intention information for shifting to a negotiation is entered by said expression of intention information entering section, said control unit sends the expression of intention information to said information terminal for an owner in order to cause it to display the information in a predetermined form and, at the same time, sends said expression of intention information to said owner in order to inform it of the information using another information communication form.

9. The vessel charter supporting system according to any one of claims 1 to 8,
characterized in that said control unit causes each of said information terminal for a charterer and said information terminal for an owner to display a screen for entering information for each item of a negotiation in negotiating a vessel charter.

10. The vessel charter supporting system according to claim 9,
characterized in that said screen for entering information for each item of a negotiation is provided with communicating means for displaying contents of the same item of a negotiation entered by the other party of the negotiation and informing to the effect that displayed contents is agreed upon with the other party of a negotiation.

11. The vessel charter supporting system according to claim 9 or claim 10,
characterized in that a list of a plurality of items of a negotiation is also displayed on said screen for entering information for each item of a negotiation and contents of the items of a negotiation agreed upon are displayed in association with each item of a negotiation in the list of the items of a negotiation.

12. The vessel charter supporting system according to claim 11,
characterized in that, if contents of items of a charter agreed upon is displayed in association with all necessary predetermined items of a negotiation in the above-mentioned items of a negotiation, the displayed contents in the list of the items of a negotiation is regarded as contents of a vessel charter.

13. The vessel charter supporting system according to claim 9 or claim 10,
characterized in that said screen for entering information for each item of a negotiation has a first message entering section for entering a message to be shown to the other party of a negotiation which is not reflected on said contents of a vessel charter and a first message displaying section in which the message entered in said first message entering section is shown to the other party of a negotiation.

14. The vessel charter supporting system according to claim 12 or claim 13,
characterized in that said contents of a vessel charter is contents of a vessel charter with conditions, and said screen for entering predetermined information in said information terminal for a charterer is provided with a conditions lifting entering section for entering to the effect that conditions are lifted with respect to the above-mentioned contents of a vessel charter with conditions, a charter failure entering section for entering to the effect that a charter is failed to be concluded and change entering section for entering to the effect that said contents of a vessel charter with conditions are changed.

15. The vessel charter supporting system according to claim 14,
characterized in that, if change is entered by said change entering section, said control unit causes each of said information terminal for a charterer and said information terminal for an owner to display a change entering screen for entering information for change including at least one of amendment, addition and deletion with respect to said contents of the vessel charter with conditions.

16. The vessel charter supporting system according to claim 15,
characterized in that change information to be entered on said screen for entering change includes addition of a charter clause.

17. The vessel charter supporting system according to claim 16,
characterized in that said screen for entering predetermined information includes a charter clause preparing screen that is displayed on said terminal for a charterer and prepares said charter clause, said storage unit is provided with a first database for storing said prepared charter clause, and an entering of an additional charter clause to be performed on said change entering screen includes a quotation of the charter clause stored in said first database.

18. The vessel charter supporting system according to any one of claims 15 to 17,
characterized in that said change entering screen is provided with a change contents displaying section for displaying said contents of change entered by said other party of a negotiation.

19. The vessel charter supporting system according to claim 18,
characterized in that, among the contents of change to be displayed on said change contents displaying section, a displaying form of at least one of an amended part, an added part and a deleted part is different from a displaying form of parts other than a changed part.

20. The vessel charter supporting system according to any one of claims 15 to 19,
characterized in that said change entering screen is provided with an agreement on change of conditions communicating section for informing said party of a negotiation to the effect that the contents displayed on said contents of change displaying section is agreed upon, and, if the parties of a negotiation mutually agreed, agreed contents of change are reflected on said contents of the vessel charter with conditions.

21. The vessel charter supporting system according to any one of claims 15 to 20,
characterized in that said change entering screen has a second message entering section for entering a message to be shown to the other party of a negotiation which is not reflected on said contents of change and a second message displaying section in which a message entered in said second message entering section is shown to the other party of a negotiation.

22. The vessel charter supporting system according to any one of claims 14 to 21,
characterized in that, if an entering is made by said conditions lifting entering section from said terminal for a charterer, said control unit regards said contents of the vessel charter with conditions as contents of a vessel charter from which conditions are lifted.

23. The vessel charter supporting system, according claim 22,
characterized in that said screen for entering predetermined information in said information terminal for an owner includes a confirmation screen for confirming said contents of a vessel charter from which conditions are lifted if an entering is made by said conditions lifting entering section, and said confirmation screen is provided with a confirmation entering section for entering to the effect that the owner confirmed said contents of a vessel charter from which conditions are lifted and transmits said contents of a vessel charter from which conditions are lifted to said information terminal for a charterer and said information terminal for an owner if an entering of confirmation is made by said confirmation entering section.

24. The vessel charter supporting system according to any one of claims 1 to 23,
characterized in that said storage unit includes a second database in which position information of a plurality of vessels, and said control unit displays the position information of vessels registered in said second database as a position list based on predetermined information entered from said information terminal for a charterer.

25. The vessel charter supporting system according to claim 24,
characterized in that said position list includes schematic information of each vessel in addition to position information of each of said plurality of vessels and predetermined conditions concerning the contents of said schematic information is set and entered from said information terminal for a charterer, whereby said control unit selectively displays only a vessel that meets said set and entered predetermined conditions from said position list.

26. The vessel charter supporting system according to claim 24 or claim 25,
characterized in that said system further comprises a position information update entering section for updating position information of a vessel to be displayed as said position list, and said control unit updates said second database based on update information entered by said position information update entering section.

27. The vessel charter supporting system according to any one of claims 24 to 26,
characterized in that said storage unit includes a third database in which detailed information about each vessel that is displayed in said position list is registered, and said position list is provided with a detailed information request instructing section for causing said information terminal for a charterer to display said detailed information about each vessel based on said third database.

28. The vessel charter supporting system according to claim 27,
characterized in that said system further comprises a detailed information update entering section for updating detailed information about said each vessel, and said control unit updates said third database based on update information entered by said detailed information update entering section.

29. The vessel charter supporting system according to claim 27 claim or 28,
characterized in that at least one of said position list and a display screen on which detailed information about each vessel that was displayed in said position list is displayed is provided with an enquiry information entering section for making an enquiry concerning the displayed vessel.

30. The vessel charter supporting system according to any one of claims 1 to 29,
characterized in that a history concerning a vessel charter entered into between said charterer and said owner is stored in said storage unit.

31. The vessel charter supporting system according to claim 30,
characterized in that said history includes contents of a charter entered into in the past and the history is made displayable appropriately on a screen of each information terminal such that the charterer or the owner can perform a negotiation smoothly.

32. A method of supporting a vessel charter for supporting a vessel charter to be entered into between an owner and a charterer, characterized by comprising the steps of:
an enquiring step of entering an enquiry concerning a vessel that meets conditions with which said charterer intends to charter a vessel or a predetermined vessel that said charterer intends to charter from an information terminal for a charterer and causing the owner to present an indication for the enquiry;
a replying step in which the owner enters an indication to enquiry information from said charterer from an information terminal for an owner and presents it to the charterer;
a shifting to negotiation step of shifting to a negotiation with a predetermined owner based on said indication information presented by the owner; and
a step in which the charterer and the owner perform a negotiation using an information terminal for a charterer and an information terminal for an owner.

33. The method of supporting a vessel charter according to claim 32,
characterized in that said step of performing a negotiation is provided with:
a first step of displaying a list of a plurality of negotiation items on each of the display screen of said information terminal for a charterer and said information terminal for an owner and at the same time displaying a predetermined screen for entering information for one of items that are not negotiated among said plurality of negotiation items to cause said charterer and said owner to enter contents of the negotiation;
a second step of asking whether or not said charterer and said owner agree on the contents of the negotiation entered by them and causing them to indicate determination of intentions; and
a third step of setting to display the agreed contents of the negotiation with respect to said one negotiation item in said list of the negotiation items in association with said agreed negotiation items and returning to said first step, and that said step of performing a negotiation repeats said first to the third step to conclude a vessel charter by filling necessary negotiation items in said negotiation items with the contents of the negotiation.

34. The method of supporting a vessel charter according to claim 32 or 33,
characterized in that said concluded vessel charter is a vessel charter with conditions, and the method further comprises:
a situation entering step in which said charterer enters any one of situations in that conditions are lifted, a charter is failed or conditions are to be amended using said information terminal for a charterer to communicate the situation to said owner;
an amendment entering step of displaying a screen for entering predetermined condition information on said information terminal for a charterer and said information terminal for an owner with respect to conditions that said charterer desires to amend to cause said charterer to enter contents of amendment for the conditions if the situation entered above-described entering step is amendment of conditions; and
an intention determining step of entering determination of an intention on whether or not said charterer and said owner agree with each other about the contents of amendment entered by them, and said situation entering step, said amendment entering step and said intention determining step are repeated until lifting of conditions or failure of a charter is entered in said situation entering step.

35. The method of supporting a vessel charter according to claim 34,
characterized in that, if the situation entered in said situation entering step is lifting of conditions, said contents of a vessel charter with conditions becomes contents of a vessel charter from which conditions are lifted and the method further comprises:
a confirmation entering step in which said owner confirms entering to the effect that said lifting of conditions using said information terminal for an owner with respect to said contents of a vessel charter from which the conditions are lifted; and
a conditions lifted vessel charter contents transmitting step of transmitting said contents of a vessel charter from which the conditions are lifted to said information terminal for a charterer and said information terminal for an owner if an entering of confirmation is made in said confirmation entering step.

36. A server that is used in a vessel charter supporting system for supporting a vessel charter to be entered into between an owner and a charterer using computers and communication lines,
characterized in that the server is used for controlling information communication between an information terminal for a charterer and an information terminal for an owner in procedures for a vessel charter in which said charterer uses said information terminal to make an enquiry concerning a vessel meeting conditions for chartering a vessel or a predetermined vessel that said charterer intends to charter and said owner uses said information terminal for an owner to make an indication to the enquiry from said charterer, and the process shifts to a negotiation step based on indication information from said owner, where said charterer and said owner performs a negotiation.

37. A database that is used in a vessel charter supporting system for supporting a vessel charter to be entered into between an owner and a charterer using computers and communication lines,
characterized in that it is used for storing predetermined information required for a vessel charter, information entered by said charterer and information entered by said owner in procedures for a vessel charter in which said charterer uses said information terminal to make an enquiry concerning a vessel meeting conditions for chartering a vessel or a predetermined vessel that said charterer intends to charter and said owner uses said information terminal for an owner to make an indication to the enquiry from said charterer, and the process shifts to a negotiation step based on indication information from said owner, where said charterer and said owner performs a negotiation.

38. A program for supporting a vessel charter to be entered into between an owner and a charterer using computers and communication lines,
characterized in that the program causes the computers to execute:
an enquiring step of entering an enquiry concerning a vessel that meets conditions with which said charterer intends to charter a vessel or a predetermined vessel that said charterer intends to charter from an information terminal for a charterer and causing the owner to present an indication for the enquiry;
a replying step in which the owner enters an indication to enquiry information from said charterer and presents it to the charterer;
a shifting to negotiation step of shifting to a negotiation with a predetermined owner based on the indication information presented by said owner; and
a step in which the charterer and the owner perform a negotiation using an information terminal for a charterer and an information terminal for an owner.

39. The program for supporting a vessel charter according to claim 37,
characterized in that said negotiation step comprises:
a first step of displaying a list of a plurality of negotiation items on each of the display screen of said information terminal for a charterer and said information terminal for an owner and at the same time displaying a predetermined screen for entering information for one of items that are not negotiated among said plurality of negotiation items to cause said charterer and said owner to enter contents of the negotiation;
a second step of asking whether or not said charterer and said owner agree on the contents of the negotiation entered by them and causing them to indicate determination of intentions; and
a third step of setting to display the agreed contents of the negotiation with respect to said one negotiation item in said list of the negotiation items in association with said agreed negotiation items and returning to said first step, and that said negotiation step repeats said first to the third step to conclude a vessel charter by filling necessary negotiation items in said negotiation items with the contents of the negotiation.

40. The program for supporting a vessel charter according to claim 38 or claim 39,
characterized in that said concluded vessel charter is a vessel charter with conditions and the program further comprises:
a situation entering step in which said charterer enters any one of situations in that conditions are lifted, a charter is failed or conditions are to be amended using said information terminal for a charterer to communicate the situation to said owner;
an amendment entering step of displaying a screen for entering predetermined condition information on said information terminal for a charterer and said information terminal for an owner with respect to conditions that said charterer desires to amend to cause said charterer to enter contents of amendment for the conditions if the situation entered in said situation entering step is amendment of conditions; and
an intention determining step of entering determination of an intention on whether or not said charterer and said owner agree with each other about the contents of amendment entered by them, and said situation entering step, said amendment entering step and said intention determining step are repeated until lifting of conditions or failure of a charter is entered in said situation entering step.

41. The program for supporting a vessel charter according to claim 40,
characterized in that, if the situation entered in said situation entering step is lifting of conditions, said contents of a vessel charter with conditions becomes contents of a vessel charter from which conditions are lifted and the method further comprises:
a confirmation entering step in which said owner confirms entering to the effect that said lifting of conditions using said information terminal for an owner with respect to said contents of a vessel charter from which the conditions are lifted; and
a conditions lifted vessel charter contents transmitting step of transmitting said contents of a vessel charter from which the conditions are lifted to said information terminal for a charterer and said information terminal for an owner if an entering of confirmation is made in said confirmation entering step.
